(19) United States
(12) Patent Application Publication
(10) Pub. No.: US 2013/0185018 A1
(43) Pub. Date: Jul. 18, 2013

(54) Apparatuses and Methods for Estimating the Yaw Angle of a Device in a Gravitational Reference System Using Measurements of Motion Sensors and a Magnetometer Attached to the Device

(71) Applicant: Hua Sheng, Clarksburg, MD (US)

(72) Inventor: Hua Sheng, Clarksburg, MD (US)

(21) Appl. No.: 13/824,538

(22) PCT Filed: Sep. 30, 2011
(86) PCT No.: PCT/US2011/054275

§ 371 Date: Mar. 18, 2013

Related U.S. Application Data
(60) Provisional application No. 61/388,865, filed on Oct. 1, 2010.
(60) Provisional application No. 61/414,582, filed on Nov. 17, 2010.
(60) Provisional application No. 61/414,570, filed on Nov. 17, 2010.
(60) Provisional application No. 61/414,560, filed on Nov. 17, 2010.

(51) Int. Cl. G01B 7/00

(52) U.S. Cl. CPC G01B 7/003
USPC 702/153

(57) ABSTRACT

Methods for estimating a yaw angle of a body reference system of a device relative to a gravitational reference system using motion sensors and a magnetometer attached to the device are provided. A method includes (A) receiving measurements from the motion sensors and the magnetometer, (B) determining a measured 3-D magnetic field, a roll, a pitch and a raw estimate of yaw in the body reference system based on the received measurements, (C) extracting a local 3-D magnetic field from the measured 3-D magnetic field, and (D) calculating yaw angle of the body reference system in the gravitational reference system based on the extracted local 3-D magnetic, the roll, the pitch and the raw estimate of yaw using at least two different methods, wherein estimated errors of the roll, the pitch, and the extracted local 3-D magnetic field affect an error of the yaw differently for the different methods.

### RELATED APPLICATION

This application is related to, and claims priority from, U.S. Provisional Patent Application Ser. No. 61/388,865, entitled “Magnetometer-Based Sensing”, filed on Oct. 1, 2011; U.S. Provisional Patent Application Ser. No. 61/414,560, entitled “Magnetometer Alignment Calibration Without Prior Knowledge of Inclination Angle and Initial Yaw Angle”, filed on Nov. 17, 2011; U.S. Provisional Patent Application Ser. No. 61/414,570, entitled “Magnetometer Attitude Independent Parameter Calibration In Closed Form”, filed on Nov. 17, 2011 and U.S. Provisional Patent Application Ser. No. 61/414,582, entitled “Dynamic Magnetic Near Field Tracking and Compensation”, filed on Nov. 17, 2011, the disclosures of which are incorporated here by reference.

### TECHNICAL FIELD

The present inventions generally relate to apparatuses and methods for estimating a yaw angle of a device in a gravitational reference system and/or for determining parameters used for extracting a static magnetic field corrected for dynamic near fields, using measurements of a magnetometer and other motion sensors. More specifically, parameters used to convert signals acquired by a magnetometer into a local magnetic field correcting for magnetometer's offset, scale and cross-coupling/skew, hard- and soft-iron effects and alignment deviations are extracted at least partially analytically using the concurrent measurements. The yaw angle of the device in the gravitational reference system is estimated in real-time using the local static magnetic field (i.e., the local magnetic field from which near fields that have been tracked are removed) and a current roll and pitch extracted based on the concurrent measurements.

### BACKGROUND

The increasingly popular and widespread mobile devices frequently include so-called nine-axis sensors the name born due to the 3-axis gyroscopes, 3-D accelerometer and 3-D magnetometer. The 3-D gyroscopes measure angular velocities. The 3-D accelerometer measures linear acceleration. The magnetometer measures a local magnetic field vector (or a deviation thereof). In spite of their popularity, the foreseeable capabilities of these nine-axis sensors are not fully exploited due to the difficulty of calibrating and removing undesirable effects from the magnetometer measurements on one hand, and the practical impossibility to make a reliable estimate of the yaw angle using only the gyroscopes and the accelerometer.

A rigid body's (i.e., by rigid body designating any device to which the magnetometer and motion sensors are attached) 3-D angular position with respect to an Earth-fixed gravitational orthogonal reference system is uniquely defined. When a magnetometer and an accelerometer are used, it is convenient to define the gravitational reference system as having the positive Z-axis along gravity, the positive X-axis pointing to magnetic North and the positive Y-axis pointing East. The accelerometer senses gravity, while from magnetometer's measurement it can be inferred from the Earth's magnetic field that points North (although it is known that the angle between the Earth's magnetic field and gravity is may be different from 90°). This manner of defining the axis of a gravitational reference system is not intended to be limiting. Other definitions of an orthogonal right-hand reference system may be derived based on the two known directions, gravity and the magnetic North.

Motion sensors attached to the 3-D body measure its position (or change thereof) in a body orthogonal reference system defined relative to the 3-D body. For example, as illustrated in FIG. 1 for an aircraft, without loss of generality, the body reference system has the positive X-axis pointing forward along the aircraft's longitudinal axis, the positive Y-axis is directed along the right wing and the positive Z-axis is determined considering a right-hand orthogonal reference system (right hand rule). If the aircraft flies horizontally, the positive Z-axis aligns to the gravitational system's Z-axis, along the gravity. While the roll and pitch in the gravitational reference system can be determined using a 3-D accelerometer and a 2 or 3-D rotational sensors attached to the body and based on the gravity's known direction (see, e.g., Liberty U.S. Pat. Nos. 7,158,118, 7,262,760 and 7,414,611), the yaw angle in the gravitational reference system is more difficult to estimate accurately, making it preferable to augment those readings with the Earth's magnetic field (or more precisely its orientation) from magnetometer measurements.

Based on Euler's theorem, the body reference system and the gravitational reference system (as two orthogonal right-hand coordinate systems) can be related by a sequence of rotations (not more than three) about coordinate axes, where successive rotations are about different axis. A sequence of such rotations is known as an Euler angle-axis sequence. Such a reference rotation sequence is illustrated in FIG. 2. The angles of these rotations are angular positions of the device in the gravitational reference system.

A 3-D magnetometer measures a 3-D magnetic field representing an overlap of a 3-D static magnetic field (e.g., Earth's magnetic field), hard- and soft-iron effects, and a 3-D dynamic near field due to external time dependent electro-magnetic fields. The measured magnetic field depends on the actual orientation of the magnetometer. If the hard-iron effects, soft-iron effects and dynamic near fields were zero, the locus of the measured magnetic field (as the magnetometer is oriented in different directions) would be a sphere of radius equal to the magnitude of the Earth's magnetic field. The non-zero hard- and soft-iron effects render the locus of the measured magnetic field to be an ellipsoid offset from origin.

Hard-iron effect is produced by materials that exhibit a constant magnetic field overlapping the Earth's magnetic field, thereby generating constant offsets of the components of the measured magnetic field. As long as the orientation and position of the sources of magnetic field due to the hard-iron effects relative to the magnetometer is constant, the corresponding offsets are also constant.

Unlike the hard-iron effect that yields a magnetic field overlapping the Earth's field, the soft-iron effect is the result of material that influences, or distorts, a magnetic field (such as, iron and nickel), but does not necessarily generate a magnetic field itself. Therefore, the soft-iron effect is a distortion of the measured field depending upon the location and characteristics of the material causing the effect relative to the magnetometer and to the Earth's magnetic field. Thus, soft-iron effects cannot be compensated with simple offsets, requiring a more complicated procedure.

The magnetic near fields are dynamic distortions of a measured magnetic field due to time-dependent magnetic fields. In absence of a reliable estimate for the yaw from three-axis accelerometer and three-axis rotational sensor (e.g., the yaw angle drift problem due to no observation on absolute yaw angle measurement), a magnetic near field compensated magnetometer's measurement can provide an important reference making it possible to correct the yaw angle drift.

Conventionally the hard- and soft-iron effects are corrected using plural magnetic field measurements. This approach is time and memory consuming. Additionally, given the dynamic nature of the distortions caused by hard- and soft-iron effects, the differences in plural magnetic measurements may also reflect changes of the local magnetic field in time leading to over-correcting or under-correcting a current measurement.

Therefore, it would be desirable to provide devices, systems and methods that enable real-time reliable use of a magnetometer together with other motion sensors attached to a device for determining orientation of the device (i.e., angular positions including a yaw angle), while avoiding the afore-described problems and drawbacks.

### SUMMARY

Devices, systems and methods using concurrent measurements from a combination of sensors including a magnetometer yield a local 3-D static magnetic field value and then an improved value of a yaw angle of a 3-D body.

According to one exemplary embodiment, a method for estimating a yaw angle of a body reference system of a device relative to a gravitational reference system using motion sensors and a magnetometer attached to the device is provided. The method includes (A) receiving measurements from the motion sensors and from the magnetometer, (B) determining a measured 3-D magnetic field, a roll, a pitch and a raw estimate of yaw of the device in the body reference system based on the received measurements, (C) extracting a static local 3-D magnetic field from the measured 3-D magnetic field, and (D) calculating a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect an error of the tilt-compensated yaw angle differently for the at least two different methods.

According to another exemplary embodiment, an apparatus including (A) a device having a rigid body, (B) a 3-D magnetometer mounted on the device and configured to generate measurements corresponding to a local magnetic field, (C) motion sensors mounted on the device and configured to generate measurements corresponding to orientation of the rigid body, and (D) at least one processing unit is provided. The at least one processing unit is configured (1) to receive measurements from the motion sensors and from the magnetometer, (2) to determine a measured 3-D magnetic field, a roll angle, a pitch angle and a raw estimate of yaw angle of the device in the body reference system based on the received measurements, (3) to extract a local 3-D magnetic field from the measured 3-D magnetic field, and (4) to calculate a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect the error of the tilt-compensated yaw angle differently for the at least two different methods.

According to another exemplary embodiment, a computer readable storage medium configured to non-transitory store executable codes which when executed on a computer make the computer to perform a method for estimating a yaw angle of an body reference system of a device relative to a gravitational reference system using motion sensors and a magnetometer attached to the device is provided. The method includes (A) receiving measurements from the motion sensors and from the magnetometer, (B) determining a measured 3-D magnetic field, a roll, a pitch and a raw estimate of yaw of the device in the body reference system based on the received measurements, (C) extracting a static local 3-D magnetic field from the measured 3-D magnetic field, and (D) calculating a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect an error of the tilt-compensated yaw angle differently for the at least two different methods.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an illustration of a 3-D body reference system;

FIG. 2 is an illustration of a transition from a gravitational reference system to a body reference system;

FIG. 3 is a block diagram of a sensing unit, according to an exemplary embodiment;

FIG. 4 is a block diagram of a method 300 for computing the yaw angle using tilt compensated roll and pitch angles according to an exemplary embodiment;

FIG. 5 illustrates orientation of the Earth's magnetic field relative to gravity;

FIG. 6 is a block diagram of a method for calibrating the attitude-independent parameters according to an exemplary embodiment;

FIG. 7 is a block diagram of a system used for collecting data to be used to calibrate the attitude-independent parameters, according to an exemplary embodiment;

FIG. 8 is a block diagram of a method for aligning a 3-D magnetometer to an Earth-fixed gravitational reference, according to an exemplary embodiment;

FIG. 9 is a block diagram of a method for aligning a 3-D magnetometer in a nine-axis system, according to an exemplary embodiment;

FIG. 10 is a block diagram of a method for tracking and compensating magnetic near fields, according to an exemplary embodiment;

FIG. 11 is a block diagram of a method for tracking and compensating for magnetic near fields, according to an exemplary embodiment;

FIG. 12 is a block diagram of a method for fusing yaw angle estimates to obtain a best yaw angle estimate, according to an exemplary embodiment;

FIG. 13 is a flow diagram of a method of estimating a yaw angle of an body reference system of a device relative to a gravitational reference system, using motion sensors and a magnetometer attached to the device, according to an exemplary embodiment; and

FIG. 14 is flow diagram of a method for calibrating a magnetometer using concurrent measurements of motion sensors and a magnetometer attached to a device, according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a sensing unit including motion sensors and a magnetometer attached to a rigid 3-D body (“the device”). However, the embodiments to be discussed next are not limited to these systems but may be used in other systems including a magnetometer or other sensor with similar properties.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment illustrated in FIG. 3, a sensing unit 100 that may be attached to a device in order to monitor the device's orientation includes motion sensors 110 and a magnetometer 120 attached to the device's rigid body 101. Concurrent measurements performed by the motion sensors 110 and the magnetometer 120 yield signals sent to a data processing unit 130 via an interface 140. In FIG. 3, the data processing unit 130 is located on the rigid body 101. However, in an alternative embodiment, the data processing unit may be remote, signals from the magnetometer and the motion sensors being transmitted to the data processing unit by a transmitter located on the device. The data processing unit 130 includes at least one processor and performs calculations using calibration parameters to convert the received signals into measured quantities including a magnetic field.

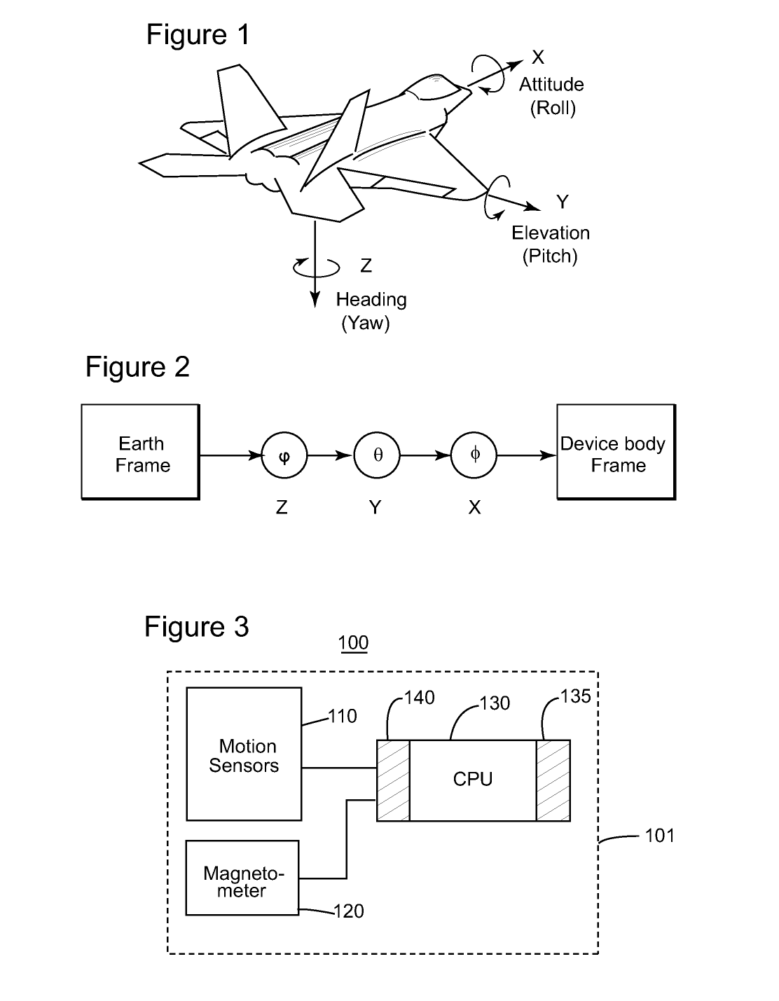

A body coordinate system may be defined relative to the device's body 101 (see, e.g., FIG. 1). The motion sensors 110 and the magnetometer 120 being fixedly attached to the rigid body 101, they generate signals related to observable (e.g., magnetic field, angular speed or linear acceleration) in the body reference system. However, in order, for example, to determine body's orientation in a reference system independent from the device one has to be able to related these measured quantities to an observer reference system. One may consider the observer's reference system to be an inertial reference frame, and the body reference system to be a non-inertial reference system. For an observer located on Earth, gravity provides one reference direction and magnetic North provides another. The observer's reference system may be defined relative to these directions. For example, a gravitational reference system may be defined to have z-axis along gravity, y-axis in a plane including gravity and the magnetic North direction, and, using the right hand rule, x-axis pointing towards East. However, this particular definition is not intended to be limiting. In the following description, the term “gravitational reference system” is used to describe a reference system defined using gravity and magnetic North.

The signals reflect quantities measured in the body reference system. These measurements in the body reference system are further processed by the data processing unit 130 to be converted into quantities corresponding to a gravitational reference system. For example, using rotation sensors and a 3-D accelerometer, a roll and pitch of the body reference system to a gravitational orthogonal reference system may be inferred. In order to accurately estimate a yaw angle of the device in the gravitational orthogonal reference system, determining the orientation of the Earth's magnetic field from the magnetic field measured in the body's reference system is necessary.

For determining the orientation of the Earth's magnetic field from the magnetic field measured in the body reference system, the data processing unit 130 corrects the measured 3-D magnetic field (which has been calculated from magnetometer signals ideally using calibration parameters) for hard-iron effects, soft-iron effects, misalignment and near fields using various parameters in a predetermined sequence of operations. Once the data processing unit 130 completes all these corrections, the resulting magnetic field may reasonable be assumed to be a local static magnetic field corresponding to the Earth's magnetic field. The Earth's magnetic field naturally points North, slightly above or below a plane perpendicular to gravity, by a known angle called “dip angle”.

A toolkit of methods that may be performed in the system 100 is described below. The data processing 130 may be connected to a computer readable medium 135 storing executable codes which, when executed, make the system 100 to perform one or more of the methods.

According to exemplary embodiments, the toolkit may include (each of the following method types are described in separate sections later in this disclosure):

(1) methods for computing a tilt compensated yaw angle,
(2) methods for determining (calibrating) attitude-independent magnetometer parameters, such as, bias, scale, and skew (cross-coupling)
(3) methods for determining (calibrating) attitude-dependent magnetometer-alignment parameters including the equivalent effect resulting from surrounding soft-iron
(4) methods for tracking and compensating for dynamic near fields, and
(5) methods for fusing different yaw angle estimates to obtain a best yaw angle estimate.

Some of these methods in addition to magnetometer data use roll and pitch angles of the device in the gravitational reference system, and relative yaw angle of the device subject to an initial unknown offset in the gravitational reference system. The roll and pitch angles in the gravitational reference system may, for example, be determined from a 3-D accelerometer and 3-D rotational sensor as described in the Liberty patents. However, the methods (1)-(5) are not limited to the manner and the particular motion sensors used to obtain the roll and pitch angle in the gravitational reference system.

Methods (2)-(4) are methods for calibrating and compensating for unintended disturbances the magnetic field value measured by magnetometer. The methods (1) and (5) focus on obtaining a value of the yaw angle. The better the calibration and compensation are, the more accurate is the value of the yaw angle obtained with methods (1) or (5). Methods (1) and/or (5) may be performed for each data set of concurrent measurements received from the magnetometer and the motion sensors. Methods (2), (3) and (4) may also be performed for each data set of concurrent measurements received from the magnetometer and the motion sensors, but performing one, some or all of the methods (2), (3) and (4) for each data set is not required. One, some, all or none, may be performed for a data set of concurrent measurements, depending on changing external conditions or a user's request.

### Methods for Computing the Tilt Compensated Yaw Angle

Methods for computing the yaw angle at any 3-D angular position (orientation) using calibrated magnetometer measurement with angle information taking tilt into consideration are provided. The methods achieve a higher accuracy than conventional method in some cases and no worse accuracy in all conditions.

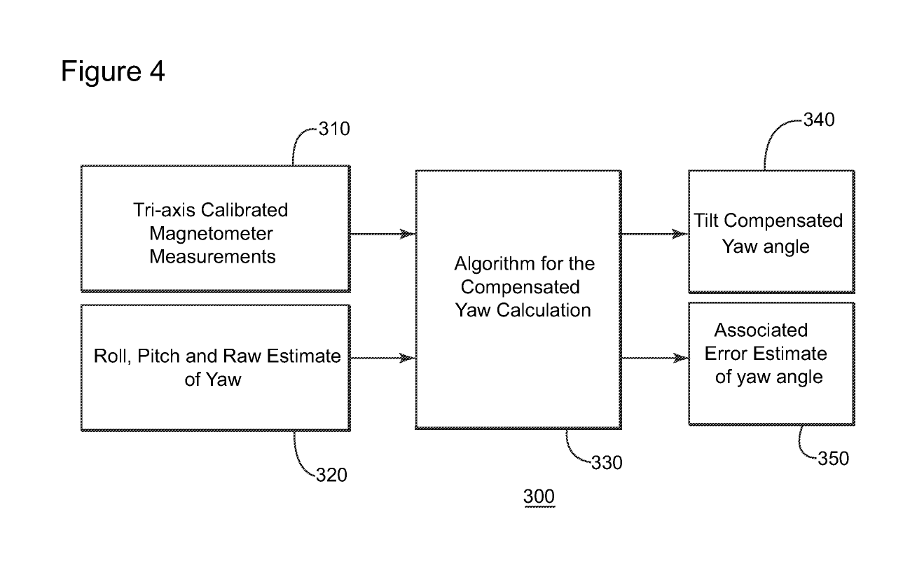

According to exemplary embodiments, FIG. 4 is a block diagram of a method 300 for computing the tilt compensated yaw angle using roll and pitch angle measurements and a raw estimate of the yaw angle. Concurrent measurements performed by a magnetometer and motion sensors permit providing as inputs of these methods a 3-D calibrated magnetometer measurement 310 and roll, pitch angle tilt corrected measurements and a raw estimate of yaw angle 320. The algorithm 330 calculates and outputs a value of the yaw angle 340 and an estimated error 350 for the yaw angle 340. The tilt is an inclination of the z axis of the body reference system relative to gravity which is the Z axis of the gravitational reference system. The tilt may be evaluated by comparing the body's linear acceleration with gravity.

The 3-D calibrated magnetometer measurement 310 is obtained from raw signals received from the magnetometer using plural parameters that account for magnetometer manufacture features, hard- and soft-iron effects, alignment and dynamic near fields. Thus, the 3-D calibrated magnetometer measurement is a static local 3-D magnetic field in the body reference system.

The following mathematical expressions refer to an Earth-fixed reference system xyz defined to have the positive z-axis is directed geocentrically (downward), and the x- and y-axis in a plane perpendicular to the gravity being directed towards magnetic North and East respectively.

The following Table 1 is a list of notations used to explain the algorithms related to the method 300.

TABLE 1

| Notation | Unit | Description |
|---|---|---|
| n | | A subscript indicating a quantity measure at time |
| | | step tₙ; this time step is an indication of concurrent |
| | | measurements, referring to the same state; |
| | | concurrent measurements may be performed in |
| | | successive time intervals. |
| i | | Time step index |
| E | | A superscript indicating an Earth-fixed reference |
| | | system |
| D | | A superscript indicating body reference system |
| × | | Matrix multiplication |
| · | | Element-wise multiplication |
| • | | Dot product of two vectors |
| −1 | | Matrix inverse |
| T | | Matrix transpose |
| \|ν\| | | The magnitude of vector ν |
| φ | radian | Yaw angle |
| θ | radian | Pitch angle |
| φ | radian | Roll angle |
| xyz | | Axes of an Earth-fixed (gravitational) reference |
| | | system |
| XYZ | | Axes of a body reference system |
| ^{D}_{E}Rₙ | | A rotation matrix that brings Earth-fixed reference |
| | | system to device's body reference system at time |
| | | step tₙ |
| R_{φ}^{Z} | | Rotation around Z axis by φ |
| R_{θ}^{Y} | | Rotation around Y axis by θ |
| R_{φ}^{X} | | Rotation around X axis by φ |
| ^{E}H₀ | Gauss | known Earth magnetic field vector in the Earth-fixed |
| | | (gravitational) reference system relative to which the |
| | | Earth-fixed gravitational reference system is defined |
| α | radian | the angle between vector ^{E}H₀ and [0 0 −1]^{T} |
| β | radian | the angle of magnetic dip (inclination) of the Earth |
| | | magnetic field vector relative to a plane |
| | | perpendicular to gravity |
| ^{D}Bₙ | Gauss | The 3-D measured (after all corrections) magnetic |
| | | field by the magnetometer in device's body |
| | | reference system at time step tₙ |
| ^{D}\hat{B}ₙ | Gauss | The estimate of ^{D}Bₙ |
| Wₙ | Gauss | The magnetometer measurement noise vector |
| ^{D}\tilde{B}ₙ | Gauss | The normalized ^{D}Bₙ |
| ^{D}\tilde{B}_{□Ag}_{ₙ} | | The component of ^{D}\tilde{B}ₙ parallel to gravity in body |
| | | reference system |
| ^{D}\tilde{B}_{⊥Ag}_{ₙ} | | The component of ^{D}\tilde{B}ₙ perpendicular to gravity in |
| | | body reference system |
| \hat{φ} | radian | Estimated yaw angle from input orientation estimate |
| \hat{θ} | radian | Estimated pitch angle from input orientation |
| | | estimate |
| \hat{φ} | radian | Estimated roll angle from input orientation estimate |
| ^{D}\tilde{\hat{B}}_{□Ag}_{ₙ} | | Estimate of ^{D}\tilde{B}_{□Ag}ₙ |
| \hat{α}ₙ | | Estimate of α at time step tₙ |
| Ê_{⊥Ag}_{ₙ} | | Defined as sin αₙ□^{D} \hat{\tilde{B}}_{⊥Ag}ₙ |
| \hat{φ}ₙ | radian | Estimate yaw angle using magnetometer |
| Ê_{⊥Ag}_{ₙ} (X) | | The X component of Ê_{⊥Ag}ₙ |
| \check{φ}ₙ | Radian | Conventionally computed yaw angle using |
| | | magnetometer |
| ε_{\check{φ}}ₙ | Radian | The estimate error of \hat{φ}ₙ |
| \tilde{φ}ₙ | Radian | The final corrected yaw angle using combined |
| | | estimates of \hat{φ}ₙ and \hat{φ}ₙ |
| σ_{x,y,z} | Gauss | The noise standard deviation of magnetic field |
| | | measurement of magnetometer along body x/y/z axis |

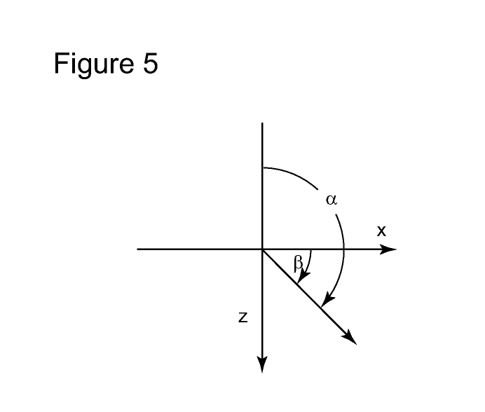

In view of FIG. 5, the rotation matrix _{E}^{D}R that brings the Earth-fixed gravitational reference system to the current device body reference system is an Euler angle sequence including three rotations and is given by

$$Equation 1$$

$$\begin{matrix}{}_{E}^{D} R = {R}_{φ}^{X} {R}_{θ}^{Y} {R}_{ϕ}^{Z} \\ = {R}_{φ}^{X} [ \begin{matrix}cos θ & 0 & - sin θ \\ 0 & 1 & 0 \\ sin θ & 0 & cos θ\end{matrix} ] [ \begin{matrix}cos ϕ & sin ϕ & 0 \\ - sin ϕ & cos ϕ & 0 \\ 0 & 0 & 1\end{matrix} ] \\ = [ \begin{matrix}1 & 0 & 0 \\ 0 & cos φ & sin φ \\ 0 & - sin φ & cos φ\end{matrix} ] [ \begin{matrix}cos θ cos ϕ & cos θ sin ϕ & - sin θ \\ - sin ϕ & cos ϕ & 0 \\ sin θcos ϕ & sin θsin ϕ & cos θ\end{matrix} ] \\ = [ \begin{matrix}cos ϕcos θ & sin ϕcos θ & - sin θ \\ cos ϕsin θsin φ - sin ϕcos φ & sin ϕsin θsin φ + cos ϕcos φ & cos θsin φ \\ cos ϕsin θcos φ + sin ϕsin φ & sin ϕsin θcos φ - cos ϕsin φ & cos θcos φ\end{matrix} ]\end{matrix}$$

As illustrated in FIG. 5, the magnetic field in the Earth-fixed gravitational reference system can be represented by

^{E}H₀=|^{E}H₀|·[sin α0−cos α]^{T} Equation 2

where α is the angle between vector ^{E}H₀ and [0 0 −1]^{T}, which is related to the dip angle β by

$$α = \frac{π}{2} + β \qquad Equation 3$$

The 3-D calibrated magnetometer measurement 310 may be expressed as

^{D}\hat{B}ₙ=^{D}Bₙ+Wₙ Equation 4

where ^{D}Bₙ is

^{D}Bₙ=_{E}^{D}Rₙ×^{E}H₀ Equation 5

and Wₙ is white Gaussian measurement noise with joint probability density function of

$$N ( {[ \begin{matrix}0 & 0 & 0\end{matrix} ]}^{T} , [ \begin{matrix}{σ}_{x}^{2} & 0 & 0 \\ 0 & {σ}_{y}^{2} & 0 \\ 0 & 0 & {σ}_{z}^{2}\end{matrix} ] ) .$$

By substituting Equations 1 and 2 into Equation 5, the actual magnetic field (without noise) is

$${}_{}^{D}{B}{}_{n}^{} = \vert {}_{}^{E}{H}{}_{0}^{} \vert \cdot sin α \cdot {[ \begin{matrix}cos θ \cdot cos φ \\ - cos ϕ \cdot sin φ + sin ϕ \cdot sin θ \cdot cos φ \\ sin ϕ \cdot sin φ + cos ϕ \cdot sin θ \cdot cos φ\end{matrix} ]}_{n} - \vert {}_{}^{E}{H}{}_{0}^{} \vert \cdot cos α \cdot {[ \begin{matrix}- sin θ \\ sin ϕ \cdot cos θ \\ cos ϕ \cdot cos θ\end{matrix} ]}_{n} \qquad Equation 6$$

Then normalized ^{D}\tilde{B}ₙ is given by

$${}_{}^{D}{\tilde{B}}{}_{n}^{} = sin α \cdot {[ \begin{matrix}\begin{matrix}cos θ \cdot cos ϕ \\ - cos φ \cdot sin ϕ + sin φ \cdot sin θ \cdot cos ϕ\end{matrix} \\ sin φ \cdot sin ϕ + cos φ \cdot sin θ \cdot cos ϕ\end{matrix} ]}_{n} - cos α \cdot {[ \begin{matrix}- sin θ \\ sin φ \cdot cos θ \\ cos φ \cdot cos θ\end{matrix} ]}_{n} \qquad Equation 7$$

The normalized ^{D}\tilde{B}ₙ is a sum of a component parallel to gravity

$${}_{}^{D}{\tilde{B}}{}_{• {Ag}_{n}}^{} {• [ \begin{matrix}- sin θ \\ sin φ \cdot cos θ \\ cos φ \cdot cos θ\end{matrix} ]}_{n} \qquad Equation 8$$

and a component perpendicular to gravity

$${}_{}^{D}{\tilde{B}}{}_{⊥ {Ag}_{n}}^{} {• [ \begin{matrix}cos θ \cdot cos ϕ \\ - cos φ \cdot sin ϕ + sin φ \cdot sin θ \cdot cos ϕ \\ sin φ \cdot sin ϕ + cos φ \cdot sin θ \cdot cos ϕ\end{matrix} ]}_{n} \qquad Equation 9$$

Note that (1) the component parallel to gravity ^{D}\tilde{B}_{□Ag} does not carry information on the yaw angle φ, and (2) the angle α is the angle between ^{D}B and the negative of the parallel normalized component −^{D}\tilde{B}_{□Ag}. Therefore, given the corrected input tilt angles \hat{θ}ₙ and \hat{φ}ₙ,

$${}_{}^{D}{{B}^{\hat{\sim}}}{}_{• {Ag}_{n}}^{} {• [ \begin{matrix}\begin{matrix}- sin \hat{θ} \\ sin \hat{φ} \cdot cos \hat{θ}\end{matrix} \\ cos \hat{φ} \cdot cos \hat{θ}\end{matrix} ]}_{n} \qquad Equation 10$$

which is then used with calibrated magnetometer input ^{D}\hat{B}ₙ to compute \hat{α}ₙ

$${\hat{α}}_{n} = {cos}^{- 1} ( \frac{{}_{}^{D}{{B}^{\hat{\sim}}}{}_{• {Ag}_{n}}^{} \cdot {}_{}^{D}{\hat{B}}{}_{n}^{}}{{\vert}^{D} {\hat{B}}_{n} \vert} ) \qquad Equation 11$$

Using the estimated ^{D}\tilde{B}_{⊥Ag}_{ₙ} and substituting Eq. (10-11) into Eq. (7) the following relationship is obtained

$$sin {\hat{α}}_{n} \cdot {}_{}^{D}{{B}^{\hat{\sim}}}{}_{⊥ {Ag}_{n}}^{} = \frac{{}_{}^{D}{\hat{B}}{}_{n}^{}}{\vert {}_{}^{D}{\hat{B}}{}_{n}^{} \vert} + cos {\hat{α}}_{n} \cdot {}_{}^{D}{{B}^{\hat{\sim}}}{}_{• {Ag}_{n}}^{} \qquad Equation 12$$

Based on Equation 12 three methods that are different from the conventional method are proposed here to compute the yaw angle. To simplify the following equations, let's define

Ê_{⊥Ag}_{ₙ}□ sin \hat{α}ₙ·^{D}{tilde over (\hat{B}_{⊥Ag}_{ₙ} Equation 13

By subtracting the product of cos \hat{φ}ₙ and the Y component of Ê_{⊥Ag}_{ₙ} from product of sin \hat{φ}ₙ and the Z component of Ê_{⊥Ag}_{ₙ}, one obtains

sin \hat{φ}ₙ·Ê_{⊥Ag}_{ₙ}(Z)−cos \hat{φ}ₙ·Ê_{⊥Ag}_{ₙ}(Y)=sin \hat{α}ₙ·sin \hat{φ}ₙ Equation 14

Similarly, by adding the product of cos \hat{φ}ₙ and the Z component of Ê_{⊥Ag}_{ₙ} and the product of sin \hat{φ}ₙ and the Y component of Ê_{⊥Ag}_{ₙ}, one obtains

sin \hat{φ}ₙ·Ê_{⊥Ag}_{ₙ}(Y)+cos \hat{φ}ₙ·Ê_{⊥Ag}_{ₙ}(Z)=sin \hat{θ}·sin \hat{α}ₙ□ cos \hat{φ}ₙ Equation 15

The X component of Ê_{⊥Ag}_{ₙ} is

Ê_{⊥Ag}_{ₙ}(X)=cos \hat{θ}ₙ·sin \hat{α}ₙ·cos \hat{φ}ₙ Equation 16

In a first method of computing the yaw angle φₙ, Equation 14 is multiplied with sin \hat{θ}ₙ and divided by Equation 15 to obtain

$${\hat{ϕ}}_{n} = {tan}^{- 1} ( \frac{sin {\hat{θ}}_{n} \cdot ( sin {\hat{φ}}_{n} \cdot {\hat{E}}_{⊥ {Ag}_{n}} ( Z ) - cos {\hat{φ}}_{n} \cdot {\hat{E}}_{⊥ {Ag}_{n}} ( Y ) )}{sin {\hat{φ}}_{n} \cdot {\hat{E}}_{⊥ {Ag}_{n}} ( Y ) + cos {\hat{φ}}_{n} \cdot {\hat{E}}_{⊥ {Ag}_{n}} ( Z )} ) \qquad Equation 17$$

In a second method of computing the yaw angle φₙ, Equation 14 is multiplied with cos \hat{θ}ₙ and divided by Equation 16 to obtain

$${\hat{ϕ}}_{n} = {tan}^{- 1} ( \frac{cos {\hat{θ}}_{n} \cdot ( sin {\hat{φ}}_{n} \cdot {\hat{E}}_{⊥ {Ag}_{n}} ( Z ) - cos {\hat{φ}}_{n} \cdot {\hat{E}}_{⊥ {Ag}_{n}} ( Y ) )}{{\hat{E}}_{⊥ {Ag}_{n}} ( X )} ) \qquad Equation 18$$

In a third method of computing the yaw angle φₙ, Equations 14-16 are combined to yield

$${\hat{ϕ}}_{n} = {tan}^{- 1} ( \frac{( sin {\hat{φ}}_{n} \cdot {\hat{E}}_{⊥ {Ag}_{n}} ( Z ) - cos {\hat{φ}}_{n} \cdot {\hat{E}}_{⊥ {Ag}_{n}} ( Y ) )}{\begin{matrix}sin {\hat{θ}}_{n} \cdot ( sin {\hat{φ}}_{n} \cdot {\hat{E}}_{⊥ {Ag}_{n}} ( Y ) + cos {\hat{φ}}_{n} \cdot {\hat{E}}_{⊥ {Ag}_{n}} ( Z ) ) + \\ cos {\hat{θ}}_{n} \cdot {\hat{E}}_{⊥ {Ag}_{n}} ( X )\end{matrix}} ) \qquad Equation 19$$

In one embodiment, the algorithm dynamically chooses the one of the above three methods that has the highest accuracy for final \hat{φ}ₙ since the errors for the three methods are different functions of both magnetometer noise along each channel and errors of the input roll and pitch angles (some methods being affected more by some error sources while being affected less by other error sources, e.g. method 1 is immune to the error of x-axis measurement of magnetometer, method 2 is function to the error of cos \hat{θ}ₙ, therefore, when the pitch angle is close to 0 degree, it is less sensitive to the error of pitch). In one embodiment, the method may be dynamically selected as follows: (1) if the absolute value of the pitch angle is between [0, π/4], use the second method; (2) if the absolute value of the pitch angle is between [π/3−π/2] use the first method; (3) otherwise, use the third method. This approach leads to a more stabilized yaw angle which is less sensitive to the orientation of the device in each individual region. Note that this same basic approach could be implemented in a single equation that merges the various estimates based on the expected accuracy of each of the elements in the equations. Also note that this same approach could be used in the calculation of pitch and roll using the magnetometer measurements.

For reference, conventional method uses the following formula to compute \check{φ}ₙ

$${{ϕ}^{}}_{n} = {tan}^{- 1} ( \frac{( \begin{matrix}cos {\hat{θ}}_{n} \cdot {\hat{B}}_{n} ( X ) + sin {\hat{θ}}_{n} \cdot \\ ( sin {\hat{φ}}_{n} \cdot {\hat{B}}_{n} ( Y ) + cos {\hat{φ}}_{n} \cdot {\hat{B}}_{n} ( Z ) )\end{matrix} )}{( - cos {\hat{φ}}_{n} \cdot {\hat{B}}_{n} ( Y ) + sin {\hat{φ}}_{n} \cdot {\hat{B}}_{n} ( Z ) )} ) \qquad Equation 20$$

This conventional calculation is affected by all error sources indiscriminately (i.e. the error of roll angle, the error of pitch angle, the errors of magnetometer measurements for each of the three axis). In one embodiment, this conventional method may be used besides one or more of the first, second and third methods.

The accuracy achieved using the best estimate (with the smallest estimated error) of the yaw angle among the first, second and third methods is therefore superior to the conventional method.

### Methods for Calibrating Attitude Independent Parameters

According to some embodiments, methods for calibrating attitude-independent parameters (scale, non-orthogonality/skew/cross-coupling, offset) of a three-axis magnetometer are provided. These attitude-independent parameters are obtained as an analytical solution in a mathematical closed form simultaneously so that no divergence issue or converging to a local minimum is concerned. Moreover, no iterative computation is required, while the method can be performed in real time. Estimation accuracy of the parameters may be used to determine whether the calibration needs to be repeated for another measurement from the magnetometer at the same or different orientation or the current parameter values meet a desired accuracy criterion.

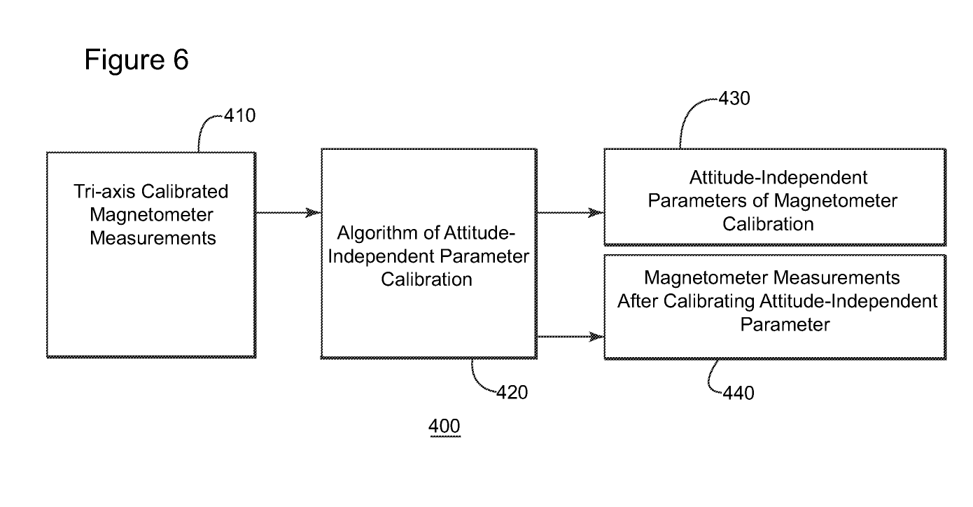

FIG. 6 is a block diagram of a method 400 for calibrating the attitude-independent parameters, according to an exemplary embodiment. The method 400 has as an input 410, raw measurements from a 3-D magnetometer. Using this input, an algorithm 420 outputs the set of attitude-independent parameters 430 and a value of the currently measured 3-D magnetic field 440 that is calculated using these attitude-independent parameters 430.

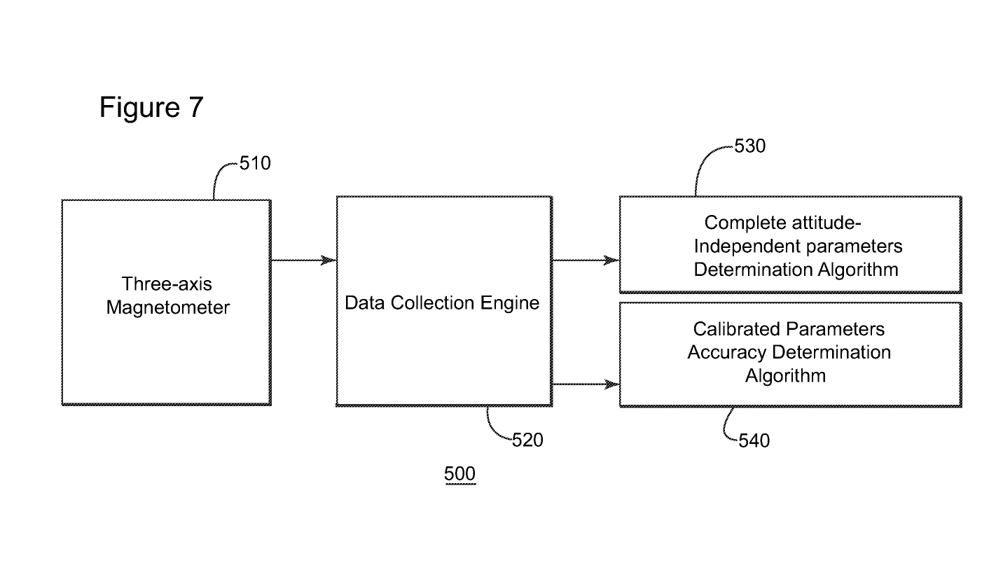

A system 500 used for collecting data to be used to calibrate the attitude-independent parameters is illustrated in FIG. 7. The system 500 consists of four blocks: sensing elements 510, a data collection engine 520, a parameter determination unit 530, and an accuracy estimation unit 540.

The sensor elements 510 output noisy and distorted signals representing sensed magnetic field values. The data collection block 520 prepares for parameter determination by accumulating the sensor data, sample-by-sample. The parameter determination unit 530 computes the attitude-independent parameters to calibrate the sensor elements to provide a measurement of constant amplitude. The accuracy estimation unit 540 computes the error of the computed attitude-independent parameters, which indicates whether a pre-determined desired accuracy has been achieved.

The following Table 2 is a list of notations used to explain the algorithms related to the method for calibrating the attitude-independent parameters.

TABLE 2

| Notation | Unit | Description |
|---|---|---|
| H, ^{E}\vec{H} | Gauss | Actual earth magnetic field vector in the earth-fixed |
| | | reference system |
| Bₖ | Gauss | The measurement vector of the magnetic field by the |
| | | magnetometer including magnetic induction at time |
| | | step tₖ in the sensor body reference system |
| I_{3×3} | | A 3 × 3 identity matrix |
| D | | Symmetric non-orthogonal 3 × 3 matrix |
| O | | Orthogonal matrix representing pure rotation for |
| | | alignment |
| Aₖ | | The rotation matrix representing the attitude of the |
| | | sensor with respect to the Earth-fixed gravitational |
| | | reference system |
| B | Gauss | The offset vector |
| nₖ | Gauss | The measurement noise vector at time step k that is |
| | | assumed to be a zero-mean Gaussian process |
| S_{M} | | Sensor scaling, a diagonal matrix |
| C_{NO} | | Sensor non-orthogonal transformation matrix |
| C_{SI} | | Soft-iron transformation matrix |
| ^{B}_{E}R | | Rotation matrix from the Earth-fixed gravitational |
| | | reference system to the device body reference |
| | | system |
| \vec{b}_{HI} | Gauss | Hard-iron effect vector |
| \vec{b}_{M} | Gauss | Sensor elements' intrinsic bias vector |
| \vec{n}_{M} | Gauss | The Gaussian wideband noise vector on |
| | | magnetometer measurement |
| i | | Reading index in the range 1, . . . , n |
| × | | Matrix multiplication |
| • | | Dot product of two vectors |
| · | | Element-wise multiplication |
| T | | Matrix transpose |
| −1 | | Matrix inverse |
| K(1) | | The 1^{st} element of vector K |
| N | | Sample at time step N |

The signals detected by the sensing elements of the magnetometer are distorted by the presence of ferromagnetic elements in their proximity. For example, the signals are distorted by the interference between the magnetic field and the surrounding installation materials, by local permanently magnetized materials, by the sensor's own scaling, cross-coupling, bias, and by technological limitations of the sensor, etc. The type and effect of magnetic distortions and sensing errors are described in many publicly available references such as W. Denne, Magnetic Compass Deviation and Correction, 3rd ed. Sheridan House Inc, 1979.

The three-axis magnetometer reading (i.e., the 3-D measured magnetic field) has been modeled in the reference “A Geometric Approach to Strapdown Magnetometer Calibration in Sensor Frame” by J. F. Vasconcelos et al., as

\vec{B}ᵢ=S_{M}×C_{NO}×(C_{SI}×_{E}^{B}Rᵢ×^{E}\vec{H}+\vec{b}_{HI})+\vec{b}_{M}+\vec{n}_{Mi} Equation 21

A more practical formulation from the reference “Complete linear attitude-independent magnetometer calibration” in The Journal of the Astronautical Sciences, 50(4):477-490, October-December 2002 by R. Alonso and M. D. Shuster and without loss of generality is:

Bₖ=(I_{3×3}+D)⁻¹×(O×Aₖ×H+b+nₖ) Equation 22

where D combines scaling and skew from both sensor contribution and soft-iron effects, O is the misalignment matrix combining both soft-iron effects and sensor's internal alignment error with respect to the Earth-fixed gravitational reference system, b is the bias due to both hard-iron effects and sensor's intrinsic contribution, n is the transformed sensor measurement noise vector with zero mean and constant standard deviation of σ.

Since both O and Aₖ only change the direction of the vector, the magnitude of O×Aₖ×H is a constant invariant of the orientation of magnetometer with respect to the Earth-fixed body reference system. Given that the points O×Aₖ×H are constrained to the sphere, the magnetometer reading Bₖ lies on an ellipsoid.

For any set of Bₖ, i.e. any portion of the ellipsoid, method of determining D and b simultaneously, analytically, with mathematical closed form are provided. Equation 22 is rewritten as

(I_{3×3}+D)×Bₖ−b=O×Aₖ×H+nₖ Equation 23

The magnitude square on both side of Equation 23 are also equal which yields

|(I_{3×3}+D)×Bₖ−b|²=O×Aₖ×H|²+|nₖ|²+2·(O×Aₖ×H)^{T}·nₖ Equation 24

Since |O×Aₖ×H|²=|H|², Equation 24 can be rewritten as

|(I_{3×3}+D)×Bₖ−b|²−|H|²=|nₖ|²+2·(O×Aₖ×H)^{T}×nₖ Equation 25

The right side of Equation 25 being a noise term, the solution to the Equation 25 can be a least square fit of |(I_{3×3}+D)×Bₖ−b|² to |H|² as

$${min}_{( D , \vec{b} )} {\sum }_{k = 1}^{n} \frac{1}{{σ}_{k}^{2}} ‖ {\vert ( {I}_{3 \times 3} + D ) \times {B}_{k} - b \vert}^{2} - ‖ {H}^{2} , \\ and {\vert H \vert}^{2} = constant \qquad Equation 26$$

However, since Equation 26 is a highly nonlinear function of D and b, there is no straightforward linear analytical solution.

By using the definitions

$$\begin{matrix}pD = {I}_{3 \times 3} + D = [ \begin{matrix}{pD}_{11} & {pD}_{12} & {pD}_{13} \\ {pD}_{12} & {pD}_{22} & {pD}_{23} \\ {pD}_{13} & {pD}_{23} & {pD}_{33}\end{matrix} ] & Equation 27 \\ \begin{matrix}E = pD \times pD \\ = [ \begin{matrix}{pD}_{11} & {pD}_{12} & {pD}_{13} \\ {pD}_{12} & {pD}_{22} & {pD}_{23} \\ {pD}_{13} & {pD}_{23} & {pD}_{33}\end{matrix} ] \times [ \begin{matrix}{pD}_{11} & {pD}_{12} & {pD}_{13} \\ {pD}_{12} & {pD}_{22} & {pD}_{23} \\ {pD}_{13} & {pD}_{23} & {pD}_{33}\end{matrix} ]\end{matrix} & Equation 28\end{matrix}$$

ignoring the noise in Equation 25, and

|pD×Bₖ−b|²=|H|² Equation 29

expanding equation 29, the following relation is obtained

$${[ \begin{matrix}{pD}_{11} \\ {pD}_{12} \\ {pD}_{13}\end{matrix} ]}^{T} \times [ \begin{matrix}{pD}_{11} \\ {pD}_{12} \\ {pD}_{13}\end{matrix} ] \cdot {B}_{x}^{2} + {[ \begin{matrix}{pD}_{12} \\ {pD}_{22} \\ {pD}_{23}\end{matrix} ]}^{T} \times [ \begin{matrix}{pD}_{12} \\ {pD}_{22} \\ {pD}_{23}\end{matrix} ] \cdot {B}_{y}^{2} + {[ \begin{matrix}{pD}_{13} \\ {pD}_{23} \\ {pD}_{33}\end{matrix} ]}^{T} \times [ \begin{matrix}{pD}_{13} \\ {pD}_{23} \\ {pD}_{33}\end{matrix} ] \cdot {B}_{z}^{2} + {2 [ \begin{matrix}{pD}_{11} \\ {pD}_{12} \\ {pD}_{13}\end{matrix} ]}^{T} \times [ \begin{matrix}{pD}_{12} \\ {pD}_{22} \\ {pD}_{23}\end{matrix} ] \cdot {B}_{x} \cdot {B}_{y} + 2 \cdot {[ \begin{matrix}{pD}_{11} \\ {pD}_{12} \\ {pD}_{13}\end{matrix} ]}^{T} \times [ \begin{matrix}{pD}_{13} \\ {pD}_{23} \\ {pD}_{33 }\end{matrix} ] \cdot {B}_{x} \cdot {B}_{z} + 2 \cdot {[ \begin{matrix}{pD}_{12} \\ {pD}_{22} \\ {pD}_{23}\end{matrix} ]}^{T} \times [ \begin{matrix}{pD}_{13} \\ {pD}_{23} \\ {pD}_{33}\end{matrix} ] \cdot {B}_{y} \cdot {B}_{z} - 2 \cdot {[ \begin{matrix}{pD}_{11} \\ {pD}_{12} \\ {pD}_{13}\end{matrix} ]}^{T} \times [ \begin{matrix}{b}_{x} \\ {b}_{y} \\ {b}_{z}\end{matrix} ] \cdot {B}_{x} - 2 \cdot {[ \begin{matrix}{pD}_{12} \\ {pD}_{22} \\ {pD}_{23}\end{matrix} ]}^{T} \times [ \begin{matrix}{b}_{x} \\ {b}_{y} \\ {b}_{z}\end{matrix} ] \cdot {B}_{y} - 2 \cdot {[ \begin{matrix}{pD}_{13} \\ {pD}_{23} \\ {pD}_{33}\end{matrix} ]}^{T} \times [ \begin{matrix}{b}_{x} \\ {b}_{y} \\ {b}_{z}\end{matrix} ] \cdot {B}_{z} + {[ \begin{matrix}{b}_{x} \\ {b}_{y} \\ {b}_{z}\end{matrix} ]}^{T} \times [ \begin{matrix}{b}_{x} \\ {b}_{y} \\ {b}_{z} \end{matrix} ] - {\vert H \vert}^{2} = 0 \qquad Equation 30$$

To simplify Equation 30, Q elements are defined as

$$Q ( 1 ) = {[ \begin{matrix}{pD}_{11} \\ {pD}_{12} \\ {pD}_{13}\end{matrix} ]}^{T} \times [ \begin{matrix}{pD}_{11} \\ {pD}_{12} \\ {pD}_{13}\end{matrix} ] , \\ Q ( 2 ) = {[ \begin{matrix}{pD}_{12} \\ {pD}_{22} \\ {pD}_{23}\end{matrix} ]}^{T} \times [ \begin{matrix}{pD}_{12} \\ {pD}_{22} \\ {pD}_{23}\end{matrix} ] , \\ Q ( 3 ) = {[ \begin{matrix}{pD}_{13} \\ {pD}_{23} \\ {pD}_{33}\end{matrix} ]}^{T} \times [ \begin{matrix}{pD}_{13} \\ {pD}_{23} \\ {pD}_{33}\end{matrix} ] \\ Q ( 4 ) = {[ \begin{matrix}{pD}_{11} \\ {pD}_{12} \\ {pD}_{13}\end{matrix} ]}^{T} \times [ \begin{matrix}{pD}_{12} \\ {pD}_{22} \\ {pD}_{23}\end{matrix} ] , \\ Q ( 5 ) = {[ \begin{matrix}{pD}_{11} \\ {pD}_{12} \\ {pD}_{13}\end{matrix} ]}^{T} \times [ \begin{matrix}{pD}_{13} \\ {pD}_{23} \\ {pD}_{33}\end{matrix} ] , \\ Q ( 6 ) = {[ \begin{matrix}{pD}_{12} \\ {pD}_{22} \\ {pD}_{23}\end{matrix} ]}^{T} \times [ \begin{matrix}{pD}_{13} \\ {pD}_{23} \\ {pD}_{33}\end{matrix} ] \\ Q ( 7 ) = {[ \begin{matrix}{pD}_{11} \\ {pD}_{12} \\ {pD}_{13}\end{matrix} ]}^{T} \times [ \begin{matrix}{b}_{x} \\ {b}_{y} \\ {b}_{z}\end{matrix} ] , \\ Q ( 8 ) = {[ \begin{matrix}{pD}_{12} \\ {pD}_{22} \\ {pD}_{23}\end{matrix} ]}^{T} \times [ \begin{matrix}{b}_{x} \\ {b}_{y} \\ {b}_{z}\end{matrix} ] , \\ Q ( 9 ) = {[ \begin{matrix}{pD}_{13} \\ {pD}_{23} \\ {pD}_{33}\end{matrix} ]}^{T} \times [ \begin{matrix}{b}_{x} \\ {b}_{y} \\ {b}_{z}\end{matrix} ] \\ Q ( 10 ) = [ \begin{matrix}{b}_{x} \\ {b}_{y} \\ {b}_{z}\end{matrix} ] \times [ \begin{matrix}{b}_{x} \\ {b}_{y} \\ {b}_{z}\end{matrix} ] - {\vert H \vert}^{2} \qquad Equation 31$$

Then based on Equation 28, E is

$${\begin{matrix}E = [ \begin{matrix}{[ \begin{matrix}{pD}_{11} \\ {pD}_{12} \\ {pD}_{13}\end{matrix} ]}^{T} \times [ \begin{matrix}{pD}_{11} \\ {pD}_{12} \\ {pD}_{13}\end{matrix} ] & {[ \begin{matrix}{pD}_{11} \\ {pD}_{12} \\ {pD}_{13}\end{matrix} ]}^{T} \times [ \begin{matrix}{pD}_{12} \\ {pD}_{22} \\ {pD}_{33}\end{matrix} ] & {[ \begin{matrix}{pD}_{11} \\ {pD}_{12} \\ {pD}_{13}\end{matrix} ]}^{T} \times [ \begin{matrix}{pD}_{13} \\ {pD}_{23} \\ {pD}_{33}\end{matrix} ] \\ {[ \begin{matrix}{pD}_{11} \\ {pD}_{12} \\ {pD}_{13}\end{matrix} ]}^{T} \times [ \begin{matrix}{pD}_{12} \\ {pD}_{22} \\ {pD}_{23}\end{matrix} ] & {[ \begin{matrix}{pD}_{12} \\ {pD}_{22} \\ {pD}_{23}\end{matrix} ]}^{T} \times [ \begin{matrix}{pD}_{12} \\ {pD}_{22} \\ {pD}_{23}\end{matrix} ] & {[ \begin{matrix}{pD}_{12} \\ {pD}_{22} \\ {pD}_{23}\end{matrix} ]}^{T} \times [ \begin{matrix}{pD}_{13} \\ {pD}_{23} \\ {pD}_{33}\end{matrix} ] \\ {[ \begin{matrix}{pD}_{11} \\ {pD}_{12} \\ {pD}_{13}\end{matrix} ]}^{T} \times [ \begin{matrix}{pD}_{13} \\ {pD}_{23} \\ {pD}_{33}\end{matrix} ] & {[ \begin{matrix}{pD}_{12} \\ {pD}_{22} \\ {pD}_{23}\end{matrix} ]}^{T} \times [ \begin{matrix}{pD}_{13} \\ {pD}_{23} \\ {pD}_{33}\end{matrix} ] & {[ \begin{matrix}{pD}_{13} \\ {pD}_{23} \\ {pD}_{33}\end{matrix} ]}^{T} \times [ \begin{matrix}{pD}_{13} \\ {pD}_{23} \\ {pD}_{33}\end{matrix} ]\end{matrix} ] \\ = [ \begin{matrix}Q ( 1 ) & Q ( 4 ) & Q ( 5 ) \\ Q ( 4 ) & Q ( 2 ) & Q ( 6 ) \\ Q ( 5 ) & Q ( 6 ) & Q ( 3 )\end{matrix} ]\end{matrix}}^{ Equation 32}$$

Matrix pD can be determined using a singular value decomposition (SVD) method

u×s×v′=svd(E) Equation 33

where s is a 3×3 diagonal matrix. Then applying square root on each element of S, one obtains another 3×3 diagonal matrix w and then pD as:

w=sqrt(s) Equation 34

pD=u×w×v′ Equation 35

Offset b is calculated as

$$b = {( pD )}^{- 1} \times [ \begin{matrix}Q ( 7 ) \\ Q ( 8 ) \\ Q ( 9 )\end{matrix} ] \qquad Equation 36$$

In order to determine Q, an average over the three magnitudes of Q(1), Q(2), and Q(3) is defined as

$$co = \frac{Q ( 1 ) + Q ( 2 ) + Q ( 3 )}{3} \qquad Equation 37$$

Using a new parameter vector K

$$K = {[ \begin{matrix}\frac{\frac{Q ( 1 ) - Q ( 3 )}{3}}{co} & \frac{\frac{Q ( 1 ) - Q ( 2 )}{3}}{co} & \frac{Q ( 4 )}{co} & \frac{Q ( 5 )}{co} & \frac{Q ( 6 )}{co} & \frac{Q ( 7 )}{co} & \frac{Q ( 8 )}{co} & \frac{Q ( 9 )}{co} & \frac{Q ( 10 )}{co}\end{matrix} ]}^{T} \qquad Equation 38$$

Equation 29 becomes

[Bₓ²+B_{y}²−2B_{z}²Bₓ²−2B_{y}²+B_{z}²2Bₓ·B_{y}2Bₓ·B_{z}2·B_{y}·B_{z}−2Bₓ−2B_{y}−2B_{z}1]×K=−(Bₓ²+B_{y}²+B_{z}²) Equation 39

Let's define an N×9 matrix T and an N×1 vector U

$$\begin{matrix}T = [ \begin{matrix}{[ \begin{matrix}{B}_{x}^{2} + {B}_{y}^{2} - 2 {B}_{z}^{2} & {B}_{x}^{2} - 2 {B}_{y}^{2} + {B}_{z}^{2} & 2 {B}_{x} \cdot {B}_{y} & 2 {B}_{x} \cdot {B}_{z} & 2 \cdot {B}_{y} \cdot {B}_{z} & - 2 {B}_{x} & - 2 {B}_{y} & - 2 {B}_{z} & 1\end{matrix} ]}_{1} \\ … \\ {[ \begin{matrix}{B}_{x}^{2} + {B}_{y}^{2} - 2 {B}_{z}^{2} & {B}_{x}^{2} - 2 {B}_{y}^{2} + {B}_{z}^{2} & 2 {B}_{x} \cdot {B}_{y} & 2 {B}_{x} \cdot {B}_{z} & 2 \cdot {B}_{y} \cdot {B}_{z} & - 2 {B}_{x} & - 2 {B}_{y} & - 2 {B}_{z} & 1\end{matrix} ]}_{N}\end{matrix} ] & Equation 40 \\ U = [ \begin{matrix}- {( {B}_{x}^{2} + {B}_{y}^{2} + {B}_{z}^{2} )}_{1} \\ … \\ - {( {B}_{x}^{2} + {B}_{y}^{2} + {B}_{z}^{2} )}_{N}\end{matrix} ] & Equation 41\end{matrix}$$

With this notation, for N sample measurements Equation 39 becomes

T×K=U Equation 42

and can be solved by

K=(T^{T}×T)⁻¹×T^{T}×U Equation 43

Then from Equations 38 and 32, E may be written as

$$\begin{matrix} E = co \cdot & Equation 44 \\ [ \begin{matrix}1 + K ( 1 ) + K ( 2 ) & K ( 3 ) & K ( 4 ) \\ K ( 3 ) & 1 + K ( 1 ) - 2 K ( 2 ) & K ( 5 ) \\ K ( 4 ) & K ( 5 ) & 1 - 2 K ( 1 ) + K ( 2 )\end{matrix} ] & \end{matrix}$$

Let's define

$$F = [ \begin{matrix}1 + K ( 1 ) + K ( 2 ) & K ( 3 ) & K ( 4 ) \\ K ( 3 ) & 1 + K ( 1 ) - 2 K ( 2 ) & K ( 5 ) \\ K ( 4 ) & K ( 5 ) & 1 - 2 K ( 1 ) + K ( 2 )\end{matrix} ] = G \times G \qquad Equation 45$$

G is then determined in the same manner as pD using Equations 33-35

pD=sqrt(co)·G Equation 46

b is calculated by combining Equations 36, 38 and 46

b=sqrt(co)·G⁻¹×[K(6)K(7)K(8)]^{T} Equation 47

Substituting the definition of K(9) in Equation 38 and Equation 47 into Equation 31, co is calculated as follows

$$co = \frac{{\vert H \vert}^{2}}{\begin{matrix}[ K ( 6 ) K ( 7 ) K ( 8 ) ] \times \\ {F}^{- 1} \times {[ K ( 6 ) K ( 7 ) K ( 8 ) ]}^{T} - K ( 9 )\end{matrix}} \qquad Equation 48$$

Finally, substituting Equation 48 into Equations 46 and 47, and then into Eq. 27, D and b are completely determined.

|H|² can be referred to be the square of the local geomagnetic field strength. Even the strength has an unknown value, it can be preset to be any arbitrary constant, the only difference for the solution being a constant scale difference on all computed 9 elements (3 scale, 3 skew, and 3 offset) of all three axes.

Based on the above-explained formalism, in a real-time exemplary implementation, for each time step, the data collection engine 520 stores two variable matrices: one 9×9 matrix named covPInvAccum_ is used to accumulate T^{T}×T, and the other variable 9×1 matrix named zAccum_ is used to accumulate T^{T}×U. At time step n+1, the matrices are updated according to the following equations

covPInvAccum_{—}_{ⁿ⁺¹}=covPInvAccum_{—}_{ⁿ}+(Tₙ₊₁^{T}×Tₙ₊₁) Equation 49

zAccum_{—}_{ⁿ⁺¹}=zAccum_{—}_{ⁿ}+(Tₙ₊₁^{T}×Uₙ₊₁) Equation 50

Tₙ₊₁, which is the element at n+1 row of T, and Uₙ₊₁, which is the element at n+1 row of U, are functions of only magnetometer sample measurement at current time step. Then, based on Equation 43, K is determined and then, G is determined using Equations 33-35. A temporary variable \tilde{b} is calculated as

\tilde{b}=G⁻¹×[K(6)K(7)K(8)]^{T} Equation 51

By pluging this \tilde{b} into Equation 48 with a substitution of Equation 45 co is obtained.

In addition, Equation 51 is substituted into Equation 47, and the calculated co is applied into Equations 46-47, and then, using Equation 27, D and b (i.e., the complete calibration parameter set) are obtained.

The following algorithm may be applied to determine the accuracy of determining D and b. The error covariance matrix of the estimate of K is given by

P_{KK}=σ_{z}²·(covPInvAccum_)⁻¹ Equation 52

where

σ_{z}²=12·|H|²·σ²+6·σ⁴ Equation 53

The Jacobian matrix of K with respect to the determined parameters

J=[bₓb_{y}b_{z}pD₁₁pD₂₂pD₃₃pD₁₂pD₁₃pD₂₃]^{T} Equation 54

is given as follows

$$\begin{matrix}\frac{\partial K}{\partial J} = \frac{1}{co} \cdot ( {M}_{1} - {M}_{2} ) & Equation 55 \\ {M}_{1} = [ \begin{matrix}0 & 0 & 0 & \frac{2}{3} {pD}_{11} & 0 & - \frac{2}{3} {pD}_{33} & \frac{2}{3} {pD}_{12} & 0 & - \frac{2}{3} {pD}_{23} \\ 0 & 0 & 0 & \frac{2}{3} {pD}_{11} & - \frac{2}{3} {pD}_{22} & 0 & 0 & \frac{2}{3} {pD}_{13} & - \frac{2}{3} {pD}_{23} \\ 0 & 0 & 0 & {pD}_{12} & {pD}_{12} & 0 & {pD}_{11} + {pD}_{22} & {pD}_{23} & {pD}_{13} \\ 0 & 0 & 0 & {pD}_{13} & 0 & {pD}_{13} & {pD}_{23} & {pD}_{11} + {pD}_{33} & {pD}_{12} \\ 0 & 0 & 0 & 0 & {pD}_{23} & {pD}_{23} & {pD}_{13} & {pD}_{12} & {pD}_{22} + {pD}_{33} \\ {pD}_{11} & {pD}_{12} & {pD}_{13} & {b}_{x} & 0 & 0 & {b}_{y} & {b}_{z} & 0 \\ {pD}_{12} & {pD}_{22} & {pD}_{23} & 0 & {b}_{y} & 0 & {b}_{x} & 0 & {b}_{z} \\ {pD}_{13} & {pD}_{23} & {pD}_{33} & 0 & 0 & {b}_{z} & 0 & {b}_{x} & {b}_{y} \\ 2 {b}_{x} & 2 {b}_{y} & 2 {b}_{z} & 0 & 0 & 0 & 0 & 0 & 0\end{matrix} ] & Equation 56 \\ {M}_{2} = K \times [ \begin{matrix}0 & 0 & 0 & \frac{4}{3} {pD}_{11} & \frac{4}{3} {pD}_{22} & \frac{4}{3} {pD}_{33} & 2 {pD}_{12} & 2 {pD}_{13} & 2 {pD}_{23}\end{matrix} ] & Equation 57\end{matrix}$$

Thus, the error covariance matrix of the estimate of J is given by

$${P}_{JJ} = {( \frac{\partial K}{\partial J} )}^{- 1} \times {P}_{KK} \times {( \frac{\partial K}{\partial J} )}^{- 1} \qquad Equation 58$$

The error of the estimate J is

ε_{J}=sqrt(diag(P_{JJ})) Equation 59

The methods for calibrating attitude-independent parameters according to the above-detailed formalism can be applied to calibrate any sensor which measures a constant physical quality vector in the earth-fixed reference system, such as accelerometer measuring the earth gravity. These methods can be applied to compute the complete parameter set to fit any ellipsoid to a sphere, where the ellipsoid can be offset from the origin and/or can be skewed. The methods can be used for dynamic time-varying |H|² as well as long as |H|² is known for each sample measurement.

The manner of defining co may be different from Equation 37, for example, other linear combinations of Q(1), Q(2), and Q(3) leading to similar or even better results. The general form of such linear combination is:

co=a₁·Q(1)+a₂·Q(2)+a₃·Q(3) Equation 60

where the sum of those coefficients is 1,i.e.,:

a₁+a₂+a₃=1 Equation 61

The equations 40 and 41 can be extended to take measurement noise in different samples into account, the extended equations using the inverse of noise variances as weights:

$$\begin{matrix}T = [ \begin{matrix}\frac{1}{{σ}_{1}^{2}} \cdot {[ \begin{matrix}{B}_{x}^{2} + {B}_{y}^{2} - 2 {B}_{z}^{2} & {B}_{x}^{2} - 2 {B}_{y}^{2} + {B}_{z}^{2} & 2 {B}_{x} \cdot {B}_{y} & 2 {B}_{x} \cdot {B}_{z} & 2 \cdot {B}_{y} \cdot {B}_{z} & - 2 {B}_{x} & - 2 {B}_{y} & - 2 {B}_{z} & 1\end{matrix} ]}_{1} \\ … \\ \frac{1}{{σ}_{N}^{2}} \cdot {[ \begin{matrix}{B}_{x}^{2} + {B}_{y}^{2} - 2 {B}_{z}^{2} & {B}_{x}^{2} - 2 {B}_{y}^{2} + {B}_{z}^{2} & 2 {B}_{x} \cdot {B}_{y} & 2 {B}_{x} \cdot {B}_{z} & 2 \cdot {B}_{y} \cdot {B}_{z} & - 2 {B}_{x} & - 2 {B}_{y} & - 2 {B}_{z} & 1\end{matrix} ]}_{N}\end{matrix} ] & Equation 62 \\ U = [ \begin{matrix}\frac{- 1}{{σ}_{1}^{2}} \cdot {( {B}_{x}^{2} + {B}_{y}^{2} + {B}_{z}^{2} )}_{1} \\ … \\ \frac{- 1}{{σ}_{N}^{2}} \cdot {( {B}_{x}^{2} + {B}_{y}^{2} + {B}_{z}^{2} )}_{N}\end{matrix} ] & Equation 63\end{matrix}$$

Other functions of measurement error can also serve as weights for T and U in a similar manner.

Conventional nonlinear least square fit methods have the disadvantage that the solutions may diverge or converge to a local minimum instead of the global minimum, thereby the conventional nonlinear least square fit approach requires iterations. None of the conventional calibration method determines D and b in a complete analytical closed form. For example, one conventional method determines only scale, not accounting for the skew (i.e., only 6 of total 9 elements are determined based on the assumption that the skew is zero).

### Methods for Calibrating Attitude-Dependent Magnetometer-Alignment Parameters

Methods for aligning a 3-D magnetometer to an Earth-fixed gravitational reference system without prior knowledge about the magnetic field especially the dip angle (i.e., departure from a plane perpendicular to gravity of the local Earth magnetic field) and allowing an unknown constant initial yaw angle offset in the sequences of concurrently measured angular positions with respect to the Earth-fixed gravitational reference system are provided. The equivalent misalignment effect resulting from the soft-iron effects is also addressed in the same manner. A verification method for alignment accuracy is augmented to control the alignment algorithm dynamics. Combining the calibration and the verification makes the algorithm to converge faster, while remaining stable enough. It also enables real-time implementation to be reliable, robust, and straight-forward.

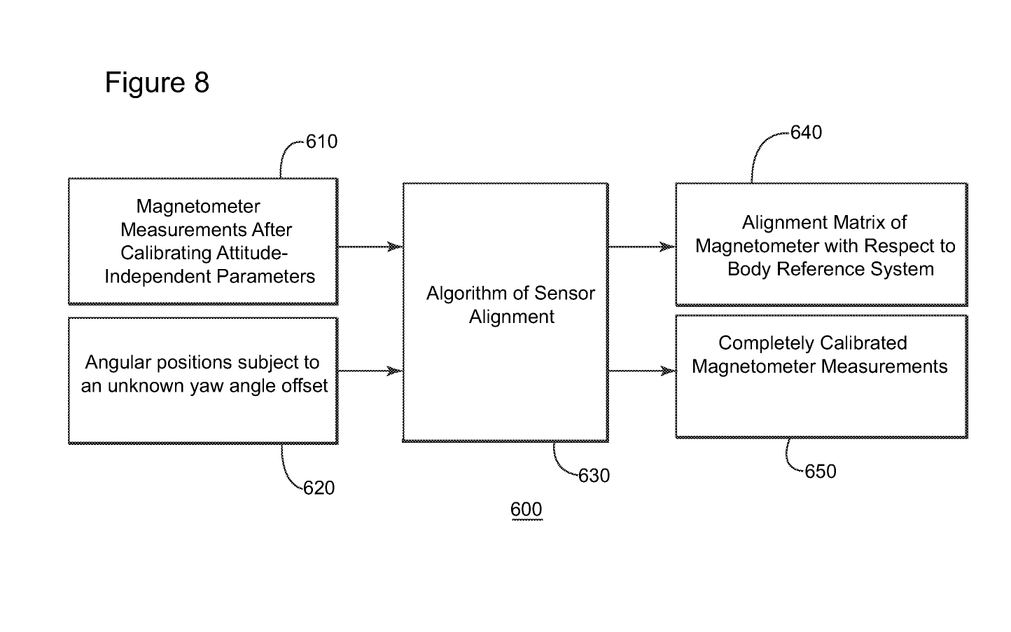

FIG. 8 is a block diagram of a method 600 for aligning a 3-D magnetometer to an Earth-fixed gravitational reference (that is, to calibrate the attitude-dependent parameters) according to an exemplary embodiment. The method 600 has as inputs the magnetic field 610 measured using the magnetometer and calculated using calibrated attitude independent parameters, and angular positions 620 subject to an unknown initial yaw offset. Using these inputs, an algorithm for sensor alignment 630 outputs an alignment matrix 640 of the 3-D magnetometer relative to the device's body reference system, the use of which enables calculating a completely calibrated value 650 of the measured magnetic field.

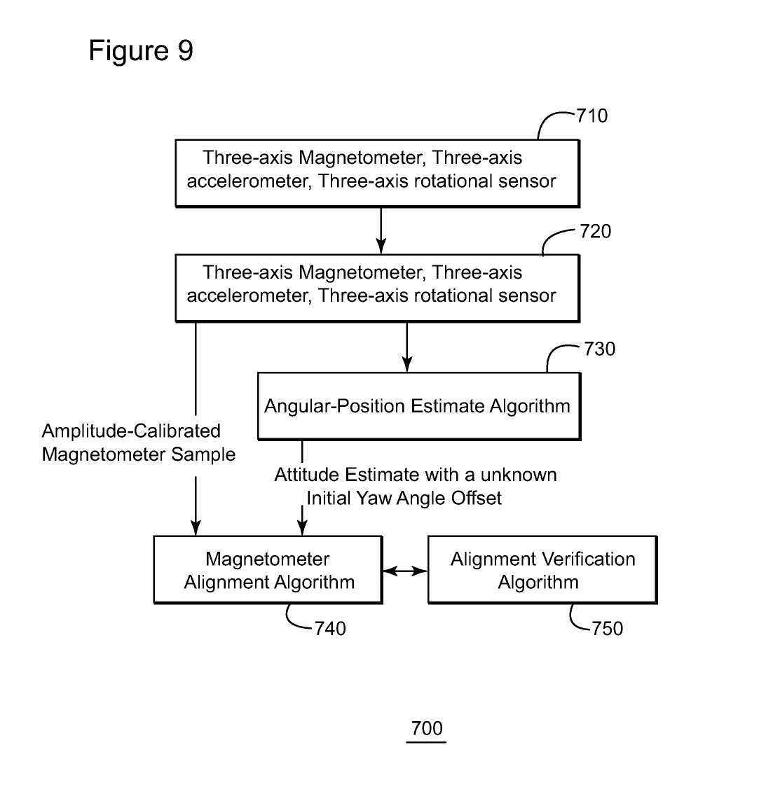

FIG. 9 is another block diagram of a method 700 for aligning a 3-D magnetometer in a nine-axis system, according to another exemplary embodiment. The block diagram of FIG. 9 emphasizes the data flow. The nine-axis system 710 includes a 3-D magnetometer, a 3-D accelerometer and a 3-D rotational sensor whose sensing signals are sent to a sensor interpretation block 720. The sensors provide noisy and distorted sensing signals that correspond to the magnetic field, the linear acceleration, and the angular rates for the device. The sensor interpretation block 720 uses pre-calculated parameters (such as, the attitude-independent parameters) to convert the sensing signals into standardized units and (1) to remove scale, skew, and offset from the magnetometer measurement but not correcting for alignment, (2) to remove scale, skew, offset, and nonlinearity for the accelerometer, (3) to remove scale, skew, offset, and linear acceleration effect for the rotational sensor, and (4) to align the accelerometer and rotational sensor to the body reference system. Those interpreted signals of the accelerometer and the rotational sensor are then used by an angular position estimate algorithm 730 (e.g., using methods described in Liberty patents or other methods) to generate an estimate of the device's attitude (i.e., angular positions with respect to the Earth-fixed gravitational reference system) except for an unknown initial yaw angle offset. The estimated attitude in a time sequence and the attitude-independent calibrated values of the magnetic field are input to the algorithm 740 for magnetometer alignment estimate. Then the estimated initial yaw angle offset and inclination angle along with magnetometer samples are then input to the alignment verification algorithm 750 for evaluating the accuracy. The alignment verification algorithm 750 provides a reliable indication as to whether the alignment estimation algorithm 740 has performed well enough.

The following Table 3 is a list of notations used to explain the algorithms related to the method for calibrating the attitude dependent parameters.

TABLE 3

| Notation | Unit | Description |
|---|---|---|
| n | | At time step tₙ |
| i | | Time step index |
| n + 1\|n + 1 | | The update value at time step tₙ₊₁ after measurement |
| | | at time step tₙ₊₁ |
| n + 1\|n | | The predicted value at time step tₙ₊₁ given the state at |
| | | time step tₙ before measurement at time step tₙ₊₁ |
| E | | Earth-fixed gravitational reference system |
| D | | The device's body reference system |
| M | | Magnetometer-sensed reference system |
| × | | Matrix multiplication |
| • | | Dot product of two vectors |
| · | | Element-wise multiplication |
| ^{E}H | Gauss | Actual Earth magnetic field vector in Earth-fixed |
| | | gravitational reference system |
| ^{M}Bₙ | Gauss | The measurement vector of the magnetic field by the |
| | | magnetometer including magnetic induction in |
| | | magnetometer-sensed reference system |
| _{E}^{M}Rₙ | | The rotation matrix brings Earth-fixed gravitational |
| | | reference system to magnetometer-sensed reference |
| | | system at time step tₙ |
| _{D}^{M}R | | misalignment between magnetometer's measurement |
| | | and device body reference system |
| _{E}^{D}Rₙ | | true angular position of device's body reference |
| | | system with respect to the Earth-fixed reference |
| | | system at time step tₙ |
| θ | Radian | Inclination (dip) angle of local geomagnetic field |
| | | relative to a plane perpendicular to gravity |
| φ₀ | Radian | Initial yaw angle offset in the sequence of angular- |
| | | positions |
| T | | Matrix transpose |
| ^{M}\tilde{B}ₙ | | The normalized ^{M}Bₙ |
| _{E}^{D}\hat{R}ₙ | | Estimated _{E}^{D}Rₙ using other sensors and sensor-fusion |
| | | algorithm but is subject to initial yaw angle offset |
| A | | Same as _{D}^{M}\hat{R} for simplicity |
| C | | $Is defined as [ \begin{matrix}cos {ϕ}_{0} • cos θ \\ sin {ϕ}_{0} • cos θ \\ sin θ\end{matrix} ]$ |
| [q₀ q₁ q₂ q₃] | | The scale and vector components of a quaternion |
| | | representing the rotation |
| EKF | | extended Kalman filter |
| X | | State of EKF |
| P | | Error covariance matrix of X |
| Zₙ₊₁ | | Measurement vector of the EKF at time step tₙ₊₁ |
| h(X) | | Observation model of EKF |
| Wₙ₊₁ | | Measurement noise vector at time step tₙ₊₁ |
| $\frac{\partial A}{\partial {q}_{0}}$ | | Partial derivative of A with respect to q₀ |
| Gₙ₊₁ | | ${}_{E}^{D}{\hat{R}}{}_{n + 1}^{} {[ \begin{matrix}cos {ϕ}_{0} • cos θ \\ sin {ϕ}_{0} • cos θ \\ sin θ\end{matrix} ]}_{n + 1 \vert n}$ |
| Hₙ₊₁ | | the Jacobian matrix of partial derivatives of h with |
| | | respect to X at time step tₙ₊₁ |
| \tilde{H}ₙ₊₁ | | The estimate of Hₙ₊₁ |
| Qₙ | | The error covariance matrix of the process model of |
| | | EKF |
| rₙ₊₁ | | The innovation vector at time step tₙ₊₁ |
| Sₙ₊₁ | | Innovation covariance matrix |
| Rₙ | | The error covariance matrix of the measurement |
| | | model of EKF |
| σₓ² | | The normalized noise variance of x-axis of |
| | | magnetometer |
| Kₙ₊₁ | | Optimal Kalman gain |
| −1 | | Matrix inverse |
| X(1:4) | | The 1^{st} to 4^{th} elements of vector X |
| \|v\| | | The magnitude of vector v |
| Const | | A predefined constant |
| Q₀ | | A baseline constant error covariance matrix of |
| | | process model |
| k₁ | | A scale factor between 0 and 1 used for adjusting Qₙ |
| k₂ | | A scale factor between 0 and 1 used for adjusting Qₙ |
| \tilde{G}ᵢ | | The best estimate of magnetic field measurement in |
| | | device-fixed body reference system for time step tᵢ |
| L | | A 3 × 3 matrix |
| u | | A 3 × 3 unitary matrix |
| s | | A 3 × 3 diagonal matrix with nonnegative diagonal |
| | | elements in decreasing order |
| v | | A 3 × 3 unitary matrix |
| w | | A 3 × 3 diagonal matrix |
| ele1 | | A 1 × 3 vector variable |
| ele2 | | A 1 × 3 vector variable |
| ele3 | | A 1 × 3 vector variable |
| ele4 | | A 1 × 3 vector variable |
| ele5 | | A 1 × 3 vector variable |
| ele6 | | A 1 × 3 vector variable |
| ele7 | | A 1 × 3 vector variable |
| ele8 | | A 1 × 3 vector variable |
| ele9 | | A 1 × 3 vector variable |

The main sources of alignment errors are imperfect installation of the magnetometer relative to the device (i.e., misalignment relative to the device's body reference system), and the influence from soft-iron effects. The attitude independent calibrated magnetometer measurement value at time step tₙ measures

^{M}Bₙ=_{E}^{M}Rₙ×^{E}H Equation 64

where _{E}^{M}Rₙ can be decomposed into

_{E}^{M}Rₙ=_{D}^{M}R×_{E}^{D}Rₙ Equation 65

_{D}^{M}R is the misalignment matrix between magnetometer's measurement and the device body reference system, _{E}^{D}Rₙ is true angular position with respect to the Earth-fixed coordinate system at time step tₙ. The best estimate of _{E}^{D}Rₙ using three-axis accelerometer and three-axis rotational sensor is denoted as _{E}^{D}\hat{R}ₙ. This estimate has high accuracy in a short of period of time except for an initial yaw angle offset.

$${}_{E}^{D}{R}{}_{n}^{} = {}_{E}^{D}{\hat{R}}{}_{n}^{} \times [ \begin{matrix}cos {ϕ}_{0} & - sin {ϕ}_{0} & 0 \\ sin {ϕ}_{0} & cos {ϕ}_{0} & 0 \\ 0 & 0 & 1\end{matrix} ] \qquad Equation 66$$

^{E}H can be represented as

^{E}H=[cos θ0 sin θ]^{T}·|^{E}H| Equation 67

Without limitation, magnetic North is used as the positive X axis of the Earth-fixed gravitational reference system. Substituting Equations 65-67 into Equation 64, one obtains

$$\begin{matrix}{}_{}^{M}{B}{}_{n}^{} = {}_{D}^{M} R \times {}_{E}^{D}{\hat{R}}{}_{n}^{} \times [ \begin{matrix}cos {ϕ}_{0} & - sin {ϕ}_{0} & 0 \\ sin {ϕ}_{0} & cos {ϕ}_{0} & 0 \\ 0 & 0 & 1\end{matrix} ] \times [ \begin{matrix}cos θ \\ 0 \\ sin θ\end{matrix} ] \cdot \vert {}^{E} H \vert & Equation 68 \\ {}_{}^{M}{\tilde{B}}{}_{i}^{} = {}_{D}^{M} R \times {}_{E}^{D}{\hat{R}}{}_{i}^{} \times [ \begin{matrix}cos {ϕ}_{0} \cdot cos θ \\ sin {ϕ}_{0} \cdot cos θ \\ sin θ\end{matrix} ] & Equation 69\end{matrix}$$

The problem then becomes to estimate _{D}^{M}R and

$$[ \begin{matrix}cos {ϕ}_{0} \cdot cos θ \\ sin {ϕ}_{0} \cdot cos θ \\ sin θ\end{matrix} ]$$

given the matrices of ^{M}\tilde{B}ₙ and _{E}^{D}\hat{R}ₙ. For simplicity, note _{D}^{M}\hat{R} as A and define C as

$$C • [ \begin{matrix}cos {ϕ}_{0} •cos θ \\ sin {ϕ}_{0} •cos θ \\ sin θ\end{matrix} ] \qquad Equation 70$$

The 6 elements of then extended Kalman filter (EKF) structure are

X=[q₀q₁q₂q₃θφ₀] Equation 71

where [q₀ q₁ q₂ q₃] are the scale and vector elements of a quaternion representing vector-rotation, θ is an inclination angle of the local magnetic field, and φ₀ is the initial yaw-angle offset in the angular position of the reference system.

The initial values of X and P₀ are

$$\begin{matrix}{X}_{0} = [ \begin{matrix}1 & 0 & 0 & 0 & 0 & 0\end{matrix} ] & Equation 72 \\ {P}_{0} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] & Equation 73\end{matrix}$$

The process model for the state is static, i.e. X_{n+1|n}=X_{n|n}. The measurement model is

$$\begin{matrix}{Z}_{n + 1} = {}_{}^{M}{\tilde{B}}{}_{n + 1}^{} \\ = h ( X ) \\ = A \times {}_{E}^{D}{R}{}_{n + 1}^{} \times [ \begin{matrix}cos {ϕ}_{0} • cos θ \\ sin {ϕ}_{0} • cos θ \\ sin θ\end{matrix} ] + {W}_{n + 1}\end{matrix} \qquad Equation 74$$

The predicted measurement is given by

$$h ( {X}_{n + 1 \vert n} ) = {A}_{n + 1 \vert n} \times {}_{E}^{D}{\hat{R}}{}_{n + 1}^{} \times {[ \begin{matrix}cos {ϕ}_{0} • cos θ \\ sin {ϕ}_{0} • cos θ \\ sin θ\end{matrix} ]}_{n + 1 \vert n} \qquad Equation 75$$

The relationship between the quaternion in the state X and the alignment matrix _{D}^{M}\hat{R} is given by,

$$Equation 76$$

$$\begin{matrix}{}_{D}^{M}{\hat{R}}{}_{n}^{} = {A}_{n} \\ = {[ \begin{matrix}{q}_{0} \cdot {q}_{0} + {q}_{1} \cdot {q}_{1} - {q}_{2} \cdot {q}_{2} - {q}_{3} \cdot {q}_{3} & 2 \cdot ( {q}_{1} \cdot {q}_{2} - {q}_{0} \cdot {q}_{3} ) & 2 \cdot ( {q}_{0} \cdot {q}_{2} + {q}_{1} \cdot {q}_{3} ) \\ 2 \cdot ( {q}_{1} \cdot {q}_{2} + {q}_{0} \cdot {q}_{3} ) & {q}_{0} \cdot {q}_{0} - {q}_{1} \cdot {q}_{1} + {q}_{2} \cdot {q}_{2} - {q}_{3} \cdot {q}_{3} & 2 \cdot ( {q}_{2} \cdot {q}_{3} - {q}_{0} \cdot {q}_{1} ) \\ 2 \cdot ( {q}_{1} \cdot {q}_{3} - {q}_{0} \cdot {q}_{2} ) & 2 \cdot ( {q}_{0} \cdot {q}_{1} + {q}_{2} \cdot {q}_{3} ) & {q}_{0} \cdot {q}_{0} - {q}_{1} \cdot {q}_{1} - {q}_{2} \cdot {q}_{2} + {q}_{3} \cdot {q}_{3}\end{matrix} ]}_{n}\end{matrix}$$

Partial derivatives of A with respect to [q₀ q₁ q₂ q₃] are given by

$$\begin{matrix}\frac{\partial A}{\partial {q}_{0}} = 2 \cdot [ \begin{matrix}{q}_{0} & - {q}_{3} & {q}_{2} \\ {q}_{3} & {q}_{0} & - {q}_{1} \\ - {q}_{2} & {q}_{1} & {q}_{0}\end{matrix} ] & Equation 77 \\ \frac{\partial A}{\partial {q}_{1}} = 2 \cdot [ \begin{matrix}{q}_{1} & {q}_{2} & {q}_{3} \\ {q}_{2} & - {q}_{1} & - {q}_{0} \\ {q}_{3} & {q}_{0} & - {q}_{1}\end{matrix} ] & Equation 78 \\ \frac{\partial A}{\partial {q}_{2}} = 2 \cdot [ \begin{matrix}- {q}_{2} & {q}_{1} & {q}_{0} \\ {q}_{1} & {q}_{2} & {q}_{3} \\ - {q}_{0} & {q}_{3} & - {q}_{2}\end{matrix} ] & Equation 79 \\ \frac{\partial A}{\partial {q}_{3}} = 2 \cdot [ \begin{matrix}- {q}_{3} & - {q}_{0} & {q}_{1} \\ {q}_{0} & - {q}_{3} & {q}_{2} \\ {q}_{1} & {q}_{2} & {q}_{3}\end{matrix} ] & Equation 80\end{matrix}$$

Partial derivative of C with respect to θ and φ₀ are

$$\begin{matrix}\frac{\partial C}{\partial θ} = [ \begin{matrix}- sin θ \cdot cos {ϕ}_{0} \\ - sin θ \cdot sin {ϕ}_{0} \\ cos θ\end{matrix} ] & Equation 81 \\ \frac{\partial C}{\partial {ϕ}_{0}} = [ \begin{matrix}- cos θ \cdot sin {ϕ}_{0} \\ cos θ \cdot cos {ϕ}_{0} \\ cos θ\end{matrix} ] & Equation 82\end{matrix}$$

G is defined as

$${G}_{n + 1} • {}_{E}^{D}{\hat{R}}{}_{n + 1}^{} \times {[ \begin{matrix}cos {ϕ}_{0} • cos θ \\ sin {ϕ}_{0} • cos θ \\ sin θ\end{matrix} ]}_{n + 1 \vert n} \qquad Equation 83$$

The Jacobian matrix whose elements are partial derivatives of h with respect to X is

$$Equation 84$$

$${\tilde{H}}_{n + 1} = [ \begin{matrix}\begin{matrix}0.5 \cdot \frac{\partial A}{\partial {q}_{0}} \times {G}_{n + 1} & 0.5 \cdot \frac{\partial A}{\partial {q}_{1}} \times {G}_{n + 1} & 0.5 \cdot \frac{\partial A}{\partial {q}_{2}} \times {G}_{n + 1}\end{matrix} \\ \begin{matrix}0.5 \cdot \frac{\partial A}{\partial {q}_{3}} \times {G}_{n + 1} & A \times {}_{E}^{D}{\hat{R}}{}_{n + 1}^{} \times \frac{\partial C}{\partial {θ}_{n + 1 \vert}} & A \times {}_{E}^{D}{\hat{R}}{}_{n + 1}^{} \times \frac{\partial C}{\partial {ϕ}_{{0}_{n + 1 \vert n}}}\end{matrix}\end{matrix} ]$$

The standard EKF computation procedure is used for state and its error covariance matrix updates as follows:
(1) Error covariance prediction

P_{n+1|n}=P_{n|n}+Qₙ Equation 85
(2) Innovation computation

rₙ₊₁=Zₙ₊₁−\hat{Z}ₙ₊₁=^{M}\tilde{B}ₙ₊₁−h(X_{n+1|n}) Equation 86

Substituting Equation 75 into Equation 86, one obtains

$${r}_{n + 1} = {}_{}^{M}{\tilde{B}}{}_{n + 1}^{} - {A}_{n + 1 \vert n} \times {}_{E}^{D}{\hat{R}}{}_{n + 1}^{} \times {[ \begin{matrix}cos {ϕ}_{0} • cos θ \\ sin {ϕ}_{0} • cos θ \\ sin θ\end{matrix} ]}_{n + 1 \vert n} \qquad Equation 87$$

(3) Kalman gain computation

Sₙ₊₁=\tilde{H}ₙ₊₁×P_{n+1|n}×(\tilde{H}ₙ₊₁)^{T}+Rₙ₊₁ Equation 88

where R is the magnetometer measurement noise covariance given by

$$\begin{matrix}{R}_{n} = {[ \begin{matrix}{σ}_{x}^{2} & 0 & 0 \\ 0 & {σ}_{y}^{2} & 0 \\ 0 & 0 & {σ}_{z}^{2}\end{matrix} ]}_{n} & Equation 89 \\ {K}_{n + 1} = {P}_{n + 1 \vert n} \times {( {\tilde{H}}_{n + 1} )}^{T} \times {( {S}_{n + 1} )}^{- 1} & Equation 90\end{matrix}$$

(4) State correction

X_{n+1|n+1}=X_{n+1|n}+Kₙ₊₁×rₙ₊₁ Equation 91
(5) Error covariance correction

P_{n+1|n+1}=(I_{6×6}−Kₙ₊₁×\tilde{H}ₙ₊₁)×P_{n+1|n} Equation 92

Beyond the standard procedure of EKF, the method runs two more steps to keep the state bounded which stabilizes the recursive filter and prevents it from diverging.
(6) Quaternion normalization, a valid quaternion representing a rotation matrix has amplitude of 1

$${X}_{n + 1} ( 1 \text{:} 4 ) = \frac{{X}_{n + 1 \vert n + 1} ( 1 \text{:} 4 )}{\vert {X}_{n + 1 \vert n + 1} ( 1 \text{:} 4 ) \vert}$$

(7) Phase wrap on inclination angle and initial yaw angle offset, a valid inclination angle is bounded between

$$- \frac{π}{2} and \frac{π}{2} ,$$

and a valid yaw angle is bounded between −π and π. First, the inclination angle estimate is limited to be within (−π, π], for example, by using

Xₙ₊₁(5)=phaseLimiter(X_{n+1|n+1}(5)) Equation 93
where y=phaseLimiter(x) function does the following:

Code 1

```
y = x;
while (1)
    if y <= −pi
        y = y + 2*pi;
    elseif y > pi
        y = y − 2*pi;
    else
        break;
    end
end
```

Secondly, the inclination angle estimate is further limited to be within

$$( - \frac{π}{2} , \frac{π}{2} ] ,$$

since this operation changes the sign of cosine and sine, the appropriate change on initial yaw angle offset estimate needs to be accompanied, the exemplary code is as follows:

Code 2

```
if X(5) > pi/2
    X(5) = pi − X(5);
    X(6) = X(6) + pi;
elseif X(5) < −pi/2
    X(5) = −pi − X(5);
    X(6) = X(6) + pi;
end
```

Last, the initial yaw angle offset estimate is limited to be within (−π, π]

Xₙ₊₁(6)=phaseLimiter(X_{n+1|n+1}(6)) Equation 94

Steps 6 and 7 are necessary and critical although they are not sufficient to keep the filter stable, and do not make the filter to converge faster.

Another control factor added in this method is the dynamic Q adjustment. In conventional methods, Q=0 since the state of estimate is constant over time. However this leads to a very slow convergence rate when the data sequence is not very friendly. For example, if initially all the data points collected are from a very small neighborhood of an angular position for a long time, which could eventually drive P to be very small since each time step renders P a little bit smaller. When more data points are then collected from wide variety of angular positions but in a very short time system, the filter is not able to quickly update its state to the truth due to very small P.

This method allows nonzero Q which enables the filter to update the system state at a reasonable pace. In general, the risk to increase P such that P becomes very large and makes the filter unstable exists, but the method allows to adjust Q dynamically and thus to ensure it has the advantage of fast convergence and also is stable enough. For this purpose, a constant baseline Q₀ is set to be the maximum change the filter can make with respect to the full dynamic range and the variable can take for each time step.

$$Equation 95$$

$${Q}_{0} = [ \begin{matrix}{Const}^{2} & 0 & 0 & 0 & 0 & 0 \\ 0 & {Const}^{2} & 0 & 0 & 0 & 0 \\ 0 & 0 & {Const}^{2} & 0 & 0 & 0 \\ 0 & 0 & 0 & {Const}^{2} & 0 & 0 \\ 0 & 0 & 0 & 0 & \frac{{π}^{2}}{4} \cdot {Const}^{2} & 0 \\ 0 & 0 & 0 & 0 & 0 & {π}^{2} \cdot {Const}^{2}\end{matrix} ]$$

Two dynamic-change multiplication factors are used in this method for adjusting the final Q at each time step:

Qₙ=k₁·k₂·Q₀ Equation 96

k₁ is designed to be a function of the difference of the estimated misalignment angles between the current system state and the system state obtained from accuracy verification algorithm. When the difference is big enough, k₁=1 enables the filter runs its maximum converge speed. When the difference is small enough comparing to the desired accuracy, k₁<<1 ensures the filter slowing down and performs micro-adjusting. In an exemplary embodiment, this relationship is implemented at each time step as follows:

Code 3

```
if diffAngle >= constant threshold (degree)
  k1 = 1;
elseif diffAngle >= 1
    k1 = α * diffAngle;
else
      k1 = α;
end
```

where α is a non-negative constant and much less than 1.

k₂ is a decay factor. When the angular positions are in the neighborhood of a fixed angular position, k₂ decays exponentially. When angular position changes more than a pre-defined threshold ANGLE_TOL, k₂ jumps back to 1. By doing this, it avoids the filter from having P much bigger when the device stays within very narrow angular position space. The stability is thus ensured. The difference between two angular positions is given by

Code 4

dcmDiff = A * Aold′;
[v, phi] = qdecomp(dcm2q(dcmDiff));

where A and Aold are direction-cosine matrix representations of two quaternions respectively, q=dcm2q(dcm) is a function converting the direction-cosine matrix into quaternion representation, and [v, phi]=qdecomp(q) is a function to breaks out the unit vector and angle of rotation components of the quaternion.

An exemplary implementation of k₂ computation is given by

Code 5

```
if phi >= ANGLE_TOL
    Aold = A;
    k2 = 1;
else
    k2 = DECAY_FACTOR * k2;
end
```

The DECAY_FACTOR may be, for example, set to be 0.95.

When the state is updated with latest measurement, the estimated inclination angle and initial yaw angle offset are used to construct the best sequence of

$${\tilde{G}}_{i} • {}_{E}^{D}{\hat{R}}{}_{i}^{} \times {[ \begin{matrix}cos {ϕ}_{0} • cos θ \\ sin {ϕ}_{0} • cos θ \\ sin θ\end{matrix} ]}_{n + 1} , \\ i = 1 , … , n + 1 \qquad Equation 97$$

Given sequence pairs of ^{M}\tilde{B}ᵢ and \tilde{G}ᵢ, i=1, . . . , n+1, solving Aₙ becomes what is known as the Wahba problem. Many alternative algorithms have been developed to solve this problem. The Landis Markley's SVD (Singular Value Decomposition) algorithm used here described as step 1-4 below:

(1) Compose the 3×3 matrix L

$${L}_{n + 1} = {\sum }_{i = 1}^{n + 1} {}_{}^{M}{\tilde{B}}{}_{i}^{} \times {( {\tilde{G}}_{i} )}^{T} \qquad Equation 98$$

(2) Decompose L using singular value decomposition (SVD)

[usv]=SVD(L) Equation 99

(3) Compute the sign and construct w

$$w = [ \begin{matrix}1 & 0 & 0 \\ 0 & 1 & 0 \\ 0 & 0 & det ( u \times {v}^{T} )\end{matrix} ] \qquad Equation 100$$

(4) Compute A

A=u×w×v^{T} Equation 101

When A is computed, the method compares this A with the one obtained in the latest state of above EKF, and the angle of difference is computed using Code 4. The angle of difference is the estimate of accuracy of the estimated alignment matrix. As previously mentioned, the angle of difference is also feedback to determine the multiplication factor of k₁ in dynamic Q adjustment in designed EKF.

For easier real-time implementation, 9 1×3 persistent vector variables are used to store historical data recursively as follows:

$$\{ \begin{matrix}ele {1}_{n + 1} = ele {1}_{n} + {}_{}^{M}{B}{}_{n + 1}^{} ( 1 ) {•}_{E}^{D} {\hat{R}}_{n + 1} ( 1 , : ) \\ ele {2}_{n + 1} = ele {2}_{n} + {}_{}^{M}{B}{}_{n + 1}^{} ( 1 ) {•}_{E}^{D} {\hat{R}}_{n + 1} ( 2 , : ) \\ ele {3}_{n + 1} = ele {3}_{n} + {}_{}^{M}{B}{}_{n + 1}^{} ( 1 ) {•}_{E}^{D} {\hat{R}}_{n + 1} ( 3 , : ) \\ ele {4}_{n + 1} = ele {4}_{n} + {}_{}^{M}{B}{}_{n + 1}^{} ( 2 ) {•}_{E}^{D} {\hat{R}}_{n + 1} ( 1 , : ) \\ ele {5}_{n + 1} = ele {5}_{n} + {}_{}^{M}{B}{}_{n + 1}^{} ( 2 ) {•}_{E}^{D} {\hat{R}}_{n + 1} ( 2 , : ) \\ ele {6}_{n + 1} = ele {6}_{n} + {}_{}^{M}{B}{}_{n + 1}^{} ( 2 ) {•}_{E}^{D} {\hat{R}}_{n + 1} ( 3 , : ) \\ ele {7}_{n + 1} = ele {7}_{n} + {}_{}^{M}{B}{}_{n + 1}^{} ( 3 ) {•}_{E}^{D} {\hat{R}}_{n + 1} ( 1 , : ) \\ ele {8}_{n + 1} = ele {8}_{n} + {}_{}^{M}{B}{}_{n + 1}^{} ( 3 ) {•}_{E}^{D} {\hat{R}}_{n + 1} ( 2 , : ) \\ ele {9}_{n + 1} = ele {9}_{n} + {}_{}^{M}{B}{}_{n + 1}^{} ( 3 ) {•}_{E}^{D} {\hat{R}}_{n + 1} ( 3 , : )\end{matrix} \qquad Equation 102$$

Therefore, the Equation 98 can be computed using

$${L}_{n + 1} = [ \begin{matrix}ele {1}_{n + 1} \times {C}_{n + 1} & ele {4}_{n + 1} \times {C}_{n + 1} & ele {7}_{n + 1} \times {C}_{n + 1} \\ ele {2}_{n + 1} \times {C}_{n + 1} & ele {5}_{n + 1} \times {C}_{n + 1} & ele {8}_{n + 1} \times {C}_{n + 1} \\ ele {3}_{n + 1} \times {C}_{n + 1} & ele {6}_{n + 1} \times {C}_{n + 1} & ele {9}_{n + 1} \times {C}_{n + 1}\end{matrix} ] \qquad Equation 103$$

The referenced sequences of angular positions may come from any other motion sensors' combination, even from another magnetometer. The method may be used for other sensor units that a nine-axis type of sensor unit with a 3-D accelerometer and a 3-D rotational sensor. The referenced sequences of angular position may be obtained using various sensor-fusion algorithms.

The Earth-fixed gravitational reference system may be defined to have other directions as the x-axis and the z-axis, instead of the gravity and the magnetic North as long as the axes of the gravitational reference system may be located using the gravity and the magnetic North directions.

If the referenced angular position does not have an unknown initial yaw offset, then the φ₀ can be the yaw angle of local magnetic field with respect to the referenced earth-fixed coordinate system, and Equation (67) is rewritten as

$${}^{E} H = \vert {}^{E} H \vert \cdot [ \begin{matrix}cos {ϕ}_{0} & - sin {ϕ}_{0} & 0 \\ sin {ϕ}_{0} & cos {ϕ}_{0} & 0 \\ 0 & 0 & 1\end{matrix} ] \times [ \begin{matrix}cos θ \\ 0 \\ sin θ\end{matrix} ] \qquad Equation 104$$

After such alignment matrix is obtained, the local magnetic field vector is also solved in earth-fixed coordinate system automatically since φ₀ and θ are solved simultaneously in the EKF state.

The algorithm of alignment can be used for any sensor 3D alignment with any referenced device body and is not limited to magnetometer or inertial body sensors.

The algorithm of alignment can take the batch of data at once to solve it in one step.

The method may employ other algorithms to solve the Wahba problem instead of the one described above for the accuracy verification algorithm.

Additionally, a stability counter can be used for ensuring that the angle difference is less than a predetermined tolerance for a number of iterations to avoid coincidence (i.e., looping while the solution cannot be improved).

Other initialization of the EKF may be used to achieve a similar result. The alignment estimation algorithm is not sensitive to the initialization.

The constants used in the above exemplary embodiments can be tuned to achieve specific purposes. k₁ and k₂ values and their adaptive change behavior can be different from the exemplary embodiment depending on the environment, sensors and application, etc.

To summarize, methods described in this section provide a simple, fast, and stable way to estimate the misalignment of magnetometer in real-time with respect to referenced device body-fixed reference system in any unknown environment, an unknown inclination angle and a unknown initial yaw angle offset in the referenced attitudes (total 5 independent variable) as long as all the other parameters (scale, skew, and offset) have already been pre-calibrated or are otherwise known with sufficient accuracy. These methods do not require prior knowledge of the local magnetic field in the Earth-fixed gravitational reference system. Verification methods for alignment accuracy are associated with the alignment algorithm to enable a real-time reliable, robust, and friendly operation.

### Methods for Tracking and Compensating for Near Fields

Methods for dynamic tracking and compensating the dynamic magnetic near fields from a magnetometer measurement using the 3-D angular position estimate of the magnetometer with respect to the Earth-fixed gravitational reference system are provided. The 3-D angular position is not perfectly accurate and can include errors in roll, pitch angles, and at least yaw angle drift. The magnetic field measurement compensated for dynamic near fields is useful for compass or 3-D angular position determination. No conventional methods capable to achieve similar results have been found.

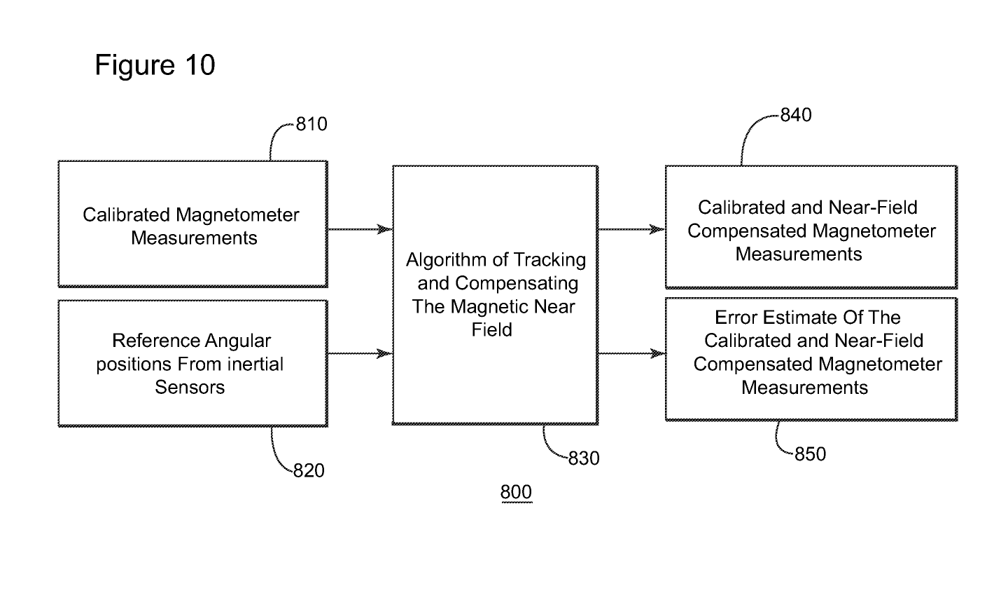

According to exemplary embodiments, FIG. 10 is a block diagram of a method 800 for tracking and compensating dynamic magnetic near fields, according to an exemplary embodiment. Measured magnetic field values calculated after completely calibrating the magnetometer 810 and reference angular positions inferred from concurrent measurements of body sensors 820 are input to an algorithm for tracking and compensating the dynamic magnetic near fields 830. The results of applying the algorithm 830 are static local 3-D magnetic field values 840 (i.e., a calibrated and near field compensated magnetometer measurements) and an error estimate 850 associated with the static local 3-D magnetic field values 840.

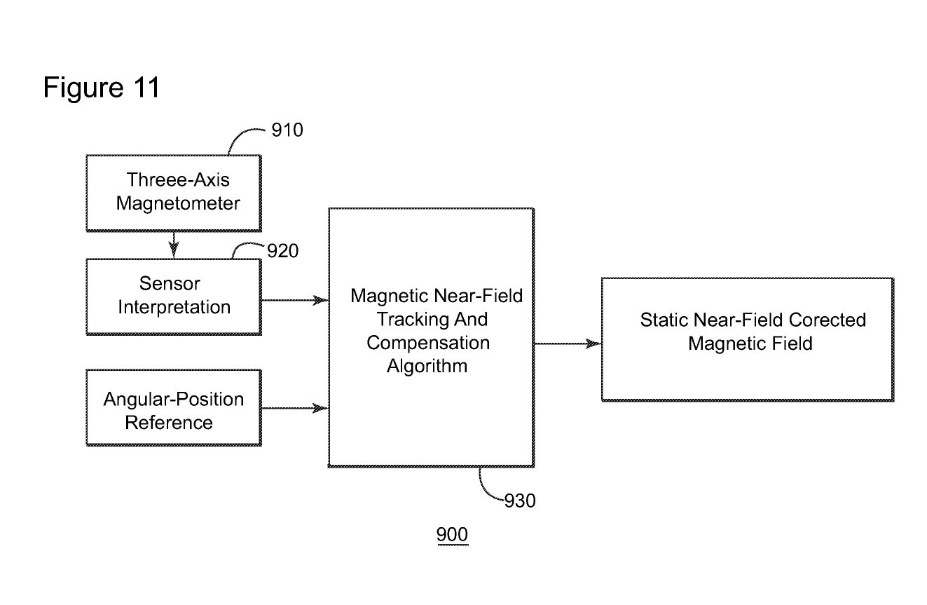

FIG. 11 is a block diagram of a method 900 for tracking and compensating for magnetic near fields, according to another exemplary embodiment. The block diagram of FIG. 11 emphasizes the data flow. A sensor block 910 including a 3-D magnetometer provides sensing signals to a sensor interpretation block 920. The sensor interpretation block 920 uses pre-calculated parameters to improve and convert the distorted sensor signals into standardized units, remove scale, skew, offset, and misalignment. Magnetic field values are output to the dynamic magnetic near field tracking and compensation algorithm 930. The angular positions of the device 940 with respect to an Earth-fixed gravitational reference system are also input to the algorithm 930. The angular positions are subject to a random roll and pitch angle error, and especially to a random yaw angle error drift. The algorithm 930 tracks changes due to the dynamic magnetic near fields, and compensates the input magnetic field value in device body reference system. The algorithm 930 also uses the compensated magnetic measurement to correct the error in the inputted angular position, especially the yaw-angle drift.

The following Table 4 is a list of notations used to explain the algorithms related to the methods for tracking and compensating near fields

TABLE 4

| Notation | Unit | Description |
|---|---|---|
| n | | At time step tₙ |
| i | | Time step index |
| E | | Earth-fixed gravitational reference system |
| D | | The device's body reference system |
| × | | Matrix multiplication |
| ␣ | | Element-wise multiplication |
| • | | Dot product of two vectors |
| −1 | | Matrix inverse |
| T | | Matrix transpose |
| \|v\| | | The magnitude of vector v |
| ^{E}Hₜₒₜ | Gauss | the total magnetic field in Earth-fixed gravitational reference system |
| ^{E}H₀ | Gauss | Known magnetic field vector in Earth-fixed gravitational reference |
| | | system, it is used for establishing the reference Earth-fixed |
| | | gravitational reference system |
| ^{E}H_{NF} | Gauss | Magnetic near field disturbance in the Earth-fixed gravitational |
| | | reference system. |
| ^{E}Ĥ_{NF}_{ₙ} | Gauss | The estimate of dynamic ^{E}H_{NF} |
| ^{E}\tilde{H}_{NF}_{ₙ} | Gauss | The estimate of latest steady ^{E}Ĥ_{NF}_{ₙ} |
| ^{D}Bₙ | Gauss | The measurement vector of the total magnetic field by the |
| | | magnetometer in device's body reference system at time step tₙ |
| ^{D}B₀ | Gauss | ^{E}H₀ in device's body reference system |
| ^{D}\hat{B}₀ | Gauss | The estimate of ^{D}B₀ |
| ^{D}B_{NF} | Gauss | The body system representation of ^{E}H_{NF} |
| ^{D}\hat{B}_{NF} | Gauss | The estimate of ^{D}B_{NF} |
| _{E}^{D}Rₙ | | The true rotation matrix brings Earth-fixed gravitational reference |
| | | system to device's body reference system at time step tₙ |
| _{E}^{D}\hat{R}ₙ | | The estimated _{E}^{D}Rₙ from other sensors which is subject to at least |
| | | yaw angle drift. |
| ^{E}A | Gauss | A virtual constant 3 × 1 vector in earth-fixed reference system |
| ^{D}A | Gauss | The representation of ^{E}A in device body reference system |
| ^{E}V | | Vector observation 3 × 2 array in Earth-fixed gravitational reference |
| | | system |
| ^{D}V | | Vector observation 3 × 2 array in device's body reference system |
| ∠XY | Radian | $The angle between two vectors = {cos}^{- 1} ( \frac{X \cdot Y}{\vert X \vert \cdot \vert Y \vert} )$ |
| ^{E}Ĥₜₒₜ | Gauss | The estimate of ^{E}Hₜₒₜ |
| rₙ₊₁ | Gauss | The difference between the ^{E}Ĥₜₒₜ_{ₙ₊₁} and ^{E}H₀ + ^{E}Ĥ_{NF}_{ₙ} |
| ΔL | Gauss | The magnitude difference between measured total magnetic field |
| | | and estimated one using ^{E}Ĥ_{NF}_{ₙ} |
| Δβ | Radian | The difference of angles within two vectors between estimated using |
| | | ^{E}Ĥ_{NF}_{ₙ} in Earth-fixed gravitational reference system and measured/ |
| | | predicted in device's body reference system |
| sampleCount_ | | A persistent variable used to record how many samples the |
| | | magnetic near field are constant |
| k₁ | | A tunable constant, typically takes value between 1 and 10 |
| k₂ | | A tunable constant, typically takes value between 1 and 10 |
| Δ\tilde{β} | Radian | The difference of angles within two vectors between estimated |
| | | using ^{E} \tilde{H}_{NF}_{ₙ} in Earth-fixed gravitational reference system and |
| | | measured/predicted in the device's body reference system |
| Δ\tilde{L} | Gauss | The magnitude difference between measured total magnetic field |
| | | and estimated one using ^{E}\tilde{H}_{NF}_{ₙ} |
| k₃ | | A tunable constant, typically takes value between 1and 10 |
| k₄ | | A tunable constant, typically takes value between 1and 10 |
| _{E}^{D}\tilde{R}ₙ | | Estimated _{E}^{D}Rₙ using ^{E}\tilde{H}_{NF}_{ₙ} |
| σ | Gauss | The noise standard deviation of magnetic field strength measure- |
| | | ment of magnetometer |
| σₓ | Gauss | The noise standard deviation of magnetic field measurement of |
| | | magnetometer along body x axis |
| α | | A single exponential smooth factor between 0 and 1 |
| ^{E}\tilde{V} | | Vector observation 3 × 2 array in earth-fixed reference system |
| | | using ^{E}\tilde{H}_{NF}_{ₙ} |
| G | | A 3 × 3 matrix |
| u | | A 3 × 3 unitary matrix |
| s | | A 3 × 3 diagonal matrix with nonnegative diagonal elements in |
| | | decreasing order |
| v | | A 3 × 3 unitary matrix |
| w | | A 3 × 3 diagonal matrix |
| ε_{yaw} | radian | the associated accuracy of yaw angle computation using ^{D}\hat{B}₀ |
| ^{E}H₀(1), | Gauss | The x and y component of ^{E}H₀, respectively |
| ^{E}H₀(2) | | |

When the magnetic field in Earth-fixed gravitational reference system is constant, the magnetic field measured by the magnetometer in the device's body reference system can be used to determine the 3-D orientation (angular position) of the device's body reference system with respect to Earth-fixed gravitational reference system. However, when the magnetic field in Earth-fixed gravitational reference system changes over time, the magnetometer measurement is significantly altered. Such time-dependent changes may be due to any near field disturbance such as earphones, speakers, cell phones, adding or removing sources of hard-iron effects or soft-iron effects, etc.

If presence of a near field disturbance is not known when the magnetometer is used for orientation estimate or compass, then the estimated orientation or North direction is inaccurate. Therefore, in order to practically use magnetometer measurements for determining 3-D orientation and compass, the magnetic near field tracking and compensation is desirable. Moreover, the angular position obtained from a combination including a 3-D accelerometer and a 3-D rotational sensor is affected by the yaw angle drift problem because there is no direct observation of absolute yaw angle of the device's body reference system with respect to the Earth-fixed gravitational reference system. The magnetic field value which is compensated for near fields corrects this deficiency, curing the yaw angle drift problem.

The calibrated magnetometer (including soft-iron and hard-iron effect calibration) measures:

^{D}Bₙ₊₁=(^{D}B₀+^{D}B_{NF})ₙ₊₁ Equation 105

where ^{D}B₀=_{E}^{D}Q×^{E}H₀ Equation 106

and ^{D}B_{NF}=_{E}^{D}Q×^{E}H_{NF} Equation 107

The method dynamically tracks ^{E}H_{NF} and uses it to estimate the ^{D}B_{NF}, then compensates it from ^{D}Bₙ to obtain ^{D}\hat{B}₀, the estimated ^{D}\hat{B}₀ is ready to be used for 3-D orientation measurement and compass. The methods may include the following steps.

Step 1: In two persistent 3×1 vectors, store the estimate of dynamic ^{E}H_{NF} and estimate of latest steady ^{E}H_{NF}, denoted as ^{E}Ĥ_{NF}_{ₙ} and ^{E}\tilde{H}_{NF}_{ₙ}, respectively.

Step 2: Construct a virtual constant 3×1 vector in Earth-fixed gravitational reference system

^{E}A=[00|^{E}H₀|]^{T} Equation 108

Step 3: Construct a vector of observations in Earth-fixed gravitational reference system

^{E}V=[^{E}H₀^{E}A] Equation 109

The following steps are executed for each time step.

Step 4: Compute the representation of ^{E}A in the device's body reference system using the referenced orientation (angular position)

^{D}Aₙ₊₁=_{E}^{D}\hat{R}ₙ₊₁×^{E}A Equation 110

By constructing ^{E}A in the manner indicated in Equation 108, the ^{D}Aₙ₊₁ is not affected by the yaw angle error in _{E}^{D}\hat{R}ₙ₊₁. The value of z axis of ^{E}A can be set to be any function of |^{E}H₀| to represent a relative weight of vector ^{E}A with respect to ^{E}H₀.

Step 5: Compute the angle ∠^{D}Bₙ₊₁^{D}Aₙ₊₁ between ^{D}Bₙ₊₁ and ^{D}Aₙ₊₁

Step 6: Predict the magnetic field (including the near fields) in Earth-fixed gravitational reference system:

^{E}Ĥₜₒₜ_{ₙ₊₁}=(_{E}^{D}\hat{R}ₙ₊₁)^{T}×^{D}Bₙ₊₁ Equation 111

Step 7: Compute the difference between the current field estimate and ^{E}Ĥₜₒₜ

rₙ₊₁=^{E}Ĥₜₒₜ_{ₙ₊₁}−(^{E}H₀+^{E}Ĥ_{NF}_{ₙ}) Equation 112

Step 8: Update the current field estimate using, for example, a single exponential smooth filter.

^{E}Ĥ_{NF}_{ₙ₊₁}=^{E}Ĥ_{NF}_{ₙ}+α□rₙ₊₁ Equation 113

Step 9: Compute the total magnitude of ^{E}Ĥ_{NF}_{ₙ₊₁}+^{E}H₀, and taking the difference between it and the magnitude of ^{D}Bₙ₊₁.

ΔLₙ₊₁=∥^{E}Ĥ_{NF}_{ₙ₊₁}+^{E}H₀|−|^{D}Bₙ₊₁∥ Equation 114

Step 10: Compute the angle ∠(^{E}Ĥ_{NF}_{ₙ₊₁}+^{E}H₀)^{E}A between ^{E}Ĥ_{NF}_{ₙ₊₁}+^{E}H₀ and ^{E}A.

Step 11: Compute the angle difference between ∠(^{E}Ĥ_{NF}_{ₙ₊₁}+^{E}H₀)^{E}A and ∠^{D}Bₙ₊₁^{D}Aₙ₊₁

Δβₙ₊₁=|∠(^{E}Ĥ_{NF}_{ₙ₊₁}+^{E}H₀)^{E}A−∠^{D}Bₙ₊₁^{D}Aₙ₊₁| Equation 115

Step 12: Evaluate if magnetic near field is steady using, for example, the following exemplary embodiment.

```
Code 6
$if ( ( {ΔL}_{n + 1} <= {k}_{1} \cdot σ ) \&\& ( {Δβ}_{n + 1} <= {k}_{2} \cdot \frac{σ}{\vert {}_{}^{D}{B}{}_{n + 1}^{} \vert} ) )$
  sampleCount _ = sampleCount _ + 1;
else
  sampleCount _ = 0;
end
```

where a persistent variable of sampleCount_ is used to record how long the magnetic near field does not vary. Exemplarily, k₁ may be set to be 3, and k₂ may be set to be 4. σ is given by

σ=\sqrt{σₓ²+σ_{y}²+σ_{z}²} Equation 116

Step 13: Update ^{E}\tilde{H}_{NF}_{ₙ} to ^{E}Ĥ_{NF}_{ₙ} when sampleCount_ is larger than a predefined threshold (e.g., the threshold may be set to be equivalent to 1 second) and then reset sampleCount_ to be 0. An exemplary embodiment of step 13 is the following code

Code 7

```
if (sampleCount _{—} > STABLE _{—} COUNT _{—} THRESHOLD)
    sampleCount _{—} =0;
    ^{E}Ĥ_{NF}_{ₙ} = ^{E}Ĥ_{NF}_{ₙ};
end
```

Step 14: Evaluate if a current sample is consistent with the latest estimated steady magnetic field by, for example, by performing the following sub-steps.

Sub-step 14.1: Compute angle difference between ∠(^{E}Ĥ_{NF}_{ₙ₊₁}+^{E}H₀)^{E}A and ∠^{D}Bₙ₊₁^{D}Aₙ₊₁

Δ\tilde{β}ₙ₊₁=|∠(^{E}Ĥ_{NF}_{ₙ₊₁}+^{E}H₀)^{E}A−∠^{D}Bₙ₊₁^{D}Aₙ₊₁| Equation 117

Sub-step 14.2: Compute the total magnitude of ^{E}Ĥ_{NF}_{ₙ₊₁}+^{E}H₀, and take the difference between it and the magnitude of ^{D}Bₙ₊₁

Δ\tilde{L}ₙ₊₁=∥^{E}\tilde{H}_{NF}_{ₙ₊₁}+^{E}H₀|−|^{D}Bₙ₊₁∥ Equation 118

Sub-step 14.3 Compare the differences computed at 14.1 and 14.2 with pre-defined thresholds using for example the following code

```
Code 8
$if ( ( Δ {\tilde{L}}_{n + 1} <= {k}_{1} \cdot σ ) \&\& ( Δ {\tilde{β}}_{n + 1} <= {k}_{2} \cdot \frac{σ}{\vert {}_{}^{D}{B}{}_{n + 1}^{} \vert} ) )$
  Yes, current sample is in the estimated steady magnetic near
  field, go to step 15 and 16.
else
  No. skip step 15 and 16, current sample is not near-field
  compensated,
  care needs to be taken for orientation estimate or compass,
  wait for next sample coming
end
```

where k₁ and k₂ can be set to be reasonably large to allow more samples to be included. Note that one option for the “else” step in Code 8 is to update the current model so that it better reflects the current magnetic field.

Step 15: If the result of step 14 is that current sample is consistent with the latest estimated steady magnetic field, then perform the following sub-steps.

Sub-step 15.1: Construct the vector observations in Earth-fixed gravitational reference system using ^{E}Ĥ_{NF}_{ₙ₊₁}+^{E}H₀

^{E}\tilde{V}ₙ₊₁=[^{E}\tilde{H}_{NF}_{ₙ₊₁}+^{E}H₀^{E}A] Equation 119

Sub-step 15.2: Construct the vector observations in device's body reference system

^{D}Vₙ₊₁=[^{D}Bₙ₊₁^{D}Aₙ₊₁] Equation 120

Sub-step 15.3 Form the 3×3 matrix with the vector observations in both the device's body reference system and the Earth-fixed gravitational reference system:

G=^{D}Vₙ₊₁×(^{E}\tilde{V}ₙ₊₁)^{T} Equation 121

Sub-step 15.4: Solve the corrected _{E}^{D}\tilde{R}ₙ. This sub-step may be implemented using various different algorithms. An exemplary embodiment using a singular value decomposition (SVD) method is described below.

(1) Decompose G using SVD

[usv]=SVD(G) Equation 122

(2) Compute the sign and construct w

$$w = [ \begin{matrix}1 & 0 & 0 \\ 0 & 1 & 0 \\ 0 & 0 & det ( u \times {v}^{T} )\end{matrix} ] \qquad Equation 123$$

(3) Compute _{E}^{D}\tilde{R}ₙ

_{E}^{D}\tilde{R}ₙ=u×w×v^{T} Equation 124

Step 16: Compute ^{D}\hat{B}₀ in which the magnetic near field is compensated

^{D}\hat{B}₀=_{E}^{D}\tilde{R}ₙ×^{E}H₀ Equation 125

Step 17: Estimate the error associated with a yaw angle determination using ^{D}\hat{B}₀

$${ɛ}_{yaw} = \sqrt{\begin{matrix}\frac{Δ {\tilde{L}}_{n + 1}^{2}}{{{}_{}^{E}{H}{}_{0}^{} ( 1 )}^{2} + {{}_{}^{E}{H}{}_{0}^{} ( 2 )}^{2}} + Δ {\tilde{β}}_{n + 1}^{2} + \\ \frac{{σ}^{2}}{3 \cdot ( {{}_{}^{E}{H}{}_{0}^{} ( 1 )}^{2} + {{}_{}^{E}{H}{}_{0}^{} ( 2 )}^{2} )}\end{matrix}} \qquad Equation 126$$

Parameters k₁ and k₂ may be set to be dynamic functions of the accuracy of magnetometer's calibration.

### Methods for Fusing Different Yaw Angle Estimates to Obtain a Best Yaw Angle Estimate.

Methods for fusing (i.e., combining) noisy estimates of the yaw angle are provided. In a nine-axis type of device, one yaw angle estimate may be obtained using a calibrated magnetometer and another short-term stable but long-term drifting yaw angle estimate may be obtained from motion sensors such as a 3-D rotation sensor (e.g., gyroscope). The methods allow smooth small adjustments when the yaw angle error is small, and quick large adjustments when the yaw angle error is large. The methods described below achieve high accuracy for the yaw-angle yielding smoothly stable values when the error is small, while a fast responsive adjustment when the error is large. Note that this same approach could be applied to other orientation and position parameters as well but in particular to pitch and roll angles.

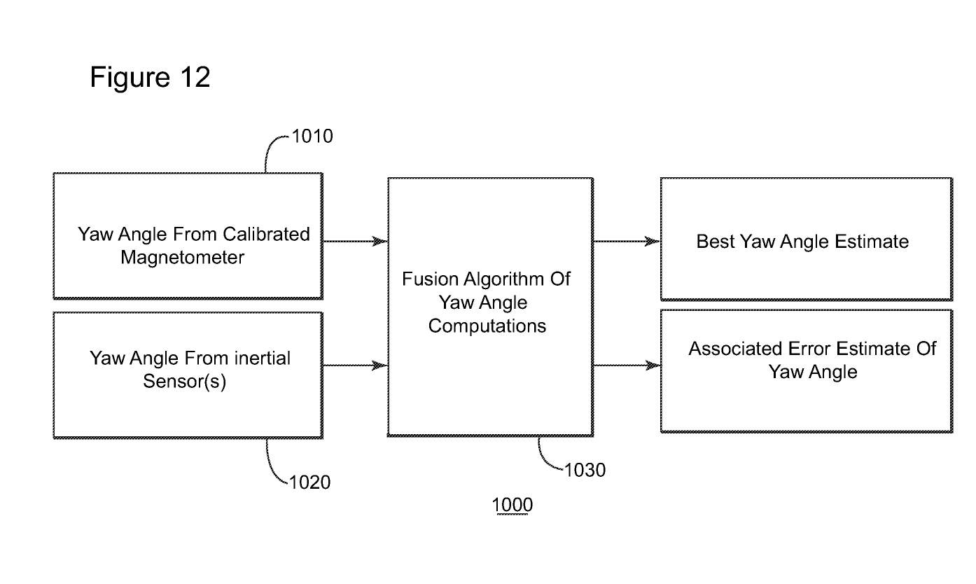

According to exemplary embodiments, FIG. 12 is a block diagram of a method 1000 for fusing yaw angle estimates to obtain a best yaw angle estimate. A yaw angle estimate from the 3-D calibrated magnetometer 1010 and a yaw angle measurement from body sensor(s) 1020 are input to a fusion algorithm 1030. The algorithm 1030 outputs a best yaw angle estimate 1040 and an error 1050 associated with the best yaw angle estimate 1040.

In the following description of algorithms related to the methods for fusing different yaw angle estimates to obtain a best yaw angle estimate, index n indicates a value at time step n.

Some embodiments of the methods use a one-dimension adaptive filter operating in the yaw-angle domain. Optionally, a Boolean variable (e.g., called “noYawCorrectFromMag_{—”}) may be used to indicate whether the method for fusing is to be performed or not (i.e., to keep the yaw angle estimate from the magnetometer). The Boolean variable's value may be toggled between a default value and the other value depending on whether predetermined condition(s) are met. The methods may include the following steps.

Step 1: Determine (using one of various methods) whether the fusion to be used (e.g., setting noYawCorrectFromMag_ to be false) depending on whether the device is stationary.

Step 2: Obtain a predicted yaw angle \hat{θ}ₙ using body sensors. For example, the full angular position may be estimated using a 3-D accelerometer and a 3-D gyroscope as the body sensors.

Step 3: Compute a yaw angle estimate φₙ using calibrated and near field compensated magnetic field estimate together with a relative initial yaw angle offset between the magnetic North and a reference yaw-zero (depending on the manner of defining the Earth—fixed gravitational reference system using the magnetic North and the gravity).

Step 4: Compute the total estimate error ε_{φ}_{ₙ} taking into account, one or more of:
a. Calibration accuracy
b. Yaw angle computation error resulting from sensor noise, roll and pitch estimate error
c. Near field compensation error

Step 5: Apply the correction scheme of adaptive filter, using the yaw-angle estimates from steps 2 and 3, \hat{φ}ₙ and φₙ, as the inputs to the adaptive filter. The output of the adaptive filter is the best estimate of the yaw angle \tilde{φ}ₙ. The adaptive filter's coefficient totalK can be computed using any one of the following procedures or a product of any combinations of those procedures.

Procedure 1: K₁ is generally a function of ratio of innovation Δφₙ to the totError ε_{φ}_{ₙ} computed in step 4. The innovation is the difference between current yaw angle φₙ from the magnetometer and the predicted best estimate of yaw angle \hat{φ}ₙ from last state of adaptive filter.

Δφₙ=φₙ−\hat{φ}ₙ Equation 127

In an exemplary embodiment, K₁ is a third order polynomial function of the ratio of innovation Δφₙ to “totError” ε_{φ}_{ₙ}

$$\begin{matrix} {ratio}_{K 1} = \frac{\vert {Δϕ}_{n} \vert}{{ɛ}_{{{ϕ}^{⋒}}_{n}}} & Equation 128 \\ {K}_{1} = {0.033}^{*} {ratio}_{K 1} \hat{} 3 - {0.083}^{*} {ratio}_{K 1} \hat{} 2 + {0.054}^{*} {ratio}_{K 1} & Equation 129\end{matrix}$$

where K₁ is bounded between 0 and 1.

Procedure 2: K₂ is a ratio of predicted yaw variance with body sensors (e.g., gyroscope) ε_{\hat{φ}}_{ₙ}² to the square of totError ε_{φ}_{ₙ}²

$${K}_{2} = \frac{{ɛ}_{{\hat{ϕ}}_{n}}^{2}}{{ɛ}_{{\hat{ϕ}}_{n}}^{2} + {ɛ}_{{{ϕ}^{⋒}}_{n}}^{2}} \qquad Equation 130$$

Procedure 3: K₃ is 1 if “totError” ε_{φ}_{ₙ} is no bigger than a threshold Δφₘₐₓ, otherwise is a function of the ratio of innovation to the predicted yaw error for the body sensors (e.g., gyro). For example:

$${ratio}_{K 3} = \frac{{ɛ}_{{{ϕ}^{⋒}}_{n}}}{{ɛ}_{{\hat{ϕ}}_{n}}} \qquad Equation 131$$

An exemplary embodiment of K₃ computation is given by

Code 9

```
if (ratio_{K3}ratioₖ₃ >= 5.0f) {
                K₃ = 0.0f;
            } elseif (ratio_{K3}>4.0f)
                K₃ = 0.0039f;
            } elseif (ratio_{K3}ratio >3.0f) {
                K₃ = 0.0156f;
            } elseif (ratio_{K3}> 2.0f) {
                K₃ = 0.0625f;
            } elseif (ratio_{K3}> 1.0f) {
                K₃ = 0.25f;
            } else {
                K₃ = 1.0f;
            }
```

Procedure 4: K₄ is 1 if the absolute value of innovation Δφₙ is greater than a threshold Δφₘₐₓ, otherwise is a constant of small value such as 0.001.

Step 6: Calculating totalK(kₙ). For example,

kₙ=K₁·K₂·K₃·K₄ Equation 132

If certain conditions are met, totalK is set to 0. Such conditions are
1) The absolute value of innovation Δφₙ is less than the accuracy of calibration;
2) The total estimate error “totError” ε_{φ}_{ₙ} is bigger than a threshold ε_{φ}_{ₙ}ₘₐₓ;
3) The member variable noYawCorrectFromMag_ is True;
4) The difference between IIR low-pass filtered version and instant version of the measured yaw angle from estimated magnetic field is bigger than a predetermined threshold (e.g., 0.04 radians).

The best yaw estimate is calculated as

\tilde{φ}ₙ=\hat{φ}ₙ+kₙ·Δφₙ Equation 133

or as

\tilde{φ}ₙ=\hat{φ}ₙ+ƒ(kₙ)·Δφₙ Equation 134

where ƒ(kₙ) is a function of kₙ. In an exemplary embodiment, a nonlinear curve passing points [0, 0.002] and [4, 1] is used and saturates at 1. In another exemplary embodiment, ƒ(kₙ)=kₙ. Given the error of yaw angle estimate from magnetometer is well bounded, it always provide a yaw angle with well-bounded accuracy, and thus can help to correct an arbitrary large drift of the yaw angle estimated from the inertial sensors (e.g., 3-D gyroscope). Since the filter is adaptive, then the correction amount for each step is dynamic, and can help reduce the yaw error much quicker but still stable when the device is stationary.

Step 7: Optionally, convert the Euler angles with corrected yaw angle back to quaternion (full angular position) if an application uses angular position.

Step 8: Optionally, noYawCorrectFromMag_ is set to be true, if both (1) the difference between corrected yaw angle and measured yaw angle using estimated magnetic field is no bigger than a predetermined threshold (e.g., 0.02 radians) and (2) the device is detected to be stationary (which may be considered true when a device is handheld and only tremor is detected).

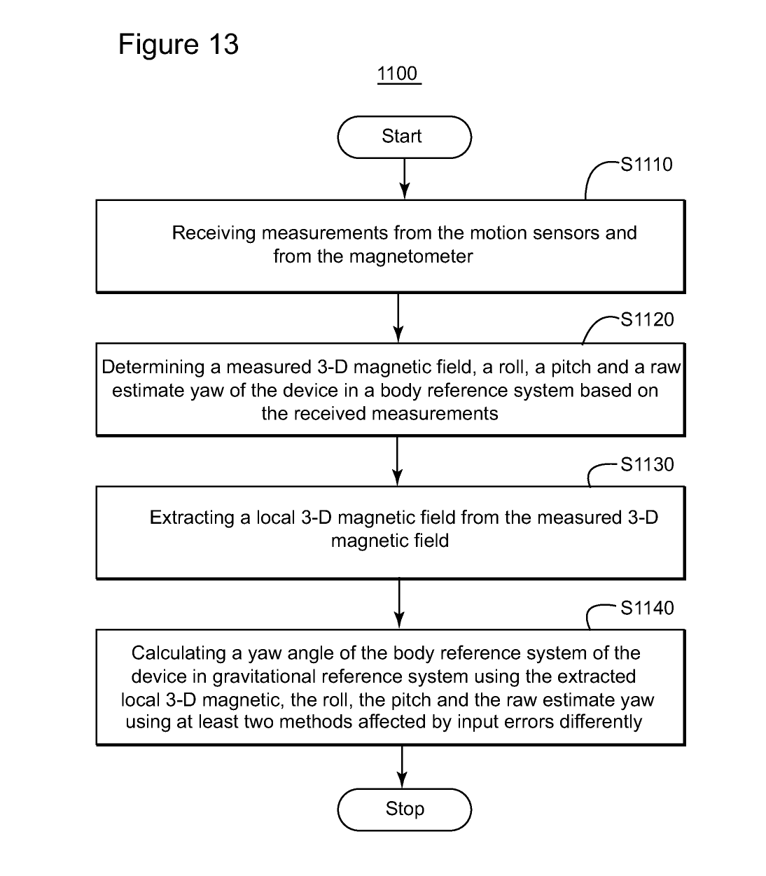

The above-described methods may be used separately or in a combination. A flow diagram of a method 1100 of estimating a yaw angle of a body reference system of a device relative to a gravitational reference system, using motion sensors and a magnetometer attached to the device, according to an exemplary embodiment is illustrated in FIG. 13. The term “motion sensors” means any sensing element(s) that can provide a measurement of roll and pitch, and at least a relative yaw (i.e., a raw estimate of yaw).

The method 1100 includes receiving measurements from the motion sensors and from the magnetometer, at S1110. The received measurements may be concurrent measurements. The term “concurrent” means in the same time interval or time step.

The method 1100 further includes determining a measured 3-D magnetic field, a roll angle, a pitch angle and a raw estimate of yaw angle of the device in the body reference system based on the received measurements, at S1120. Here the term “measured 3-D magnetic field” means a vector value determined based on measurements (signals) received from the magnetometer. Various parameters that are constants or determined during calibration procedures of the magnetometer may be used for determining the measured 3-D magnetic field. Similarly, the current roll, pitch, and raw estimate yaw are determined from measurements received from the motion sensors and using parameters that are constants or determined during calibration procedures of the motion sensors.

The method 1100 further includes extracting a local 3-D magnetic field from the measured 3-D magnetic field, at S1130. The local 3-D magnetic field may be corrected for one or more of soft-iron effect, hard-iron effect and relative alignment of the magnetometer relative to the body reference system. The local 3-D magnetic field is compensated for dynamic near fields.

The method 1100 then includes calculating a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect the error of the tilt-compensated yaw angle differently for the at least two different methods, at S1140. This operation may be performed using any of the methods for computing the yaw angle with tilt compensated using roll and pitch or the methods for fusing different yaw angle estimates to obtain a best yaw angle estimate according to the exemplary embodiments described above.

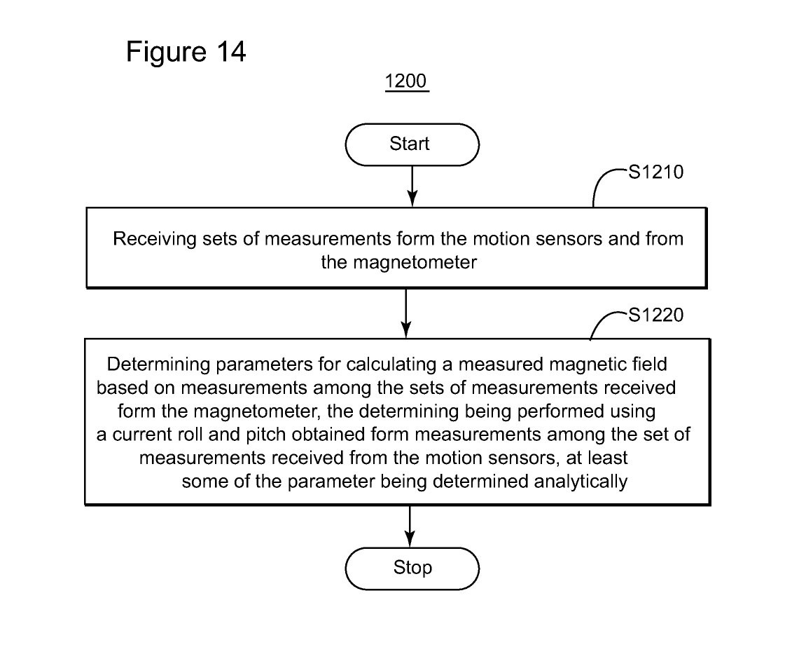

A flow diagram of a method 1200 for calibrating a magnetometer using concurrent measurements of motion sensors and a magnetometer attached to a device, according to an exemplary embodiment is illustrated in FIG. 14. The method 1200 includes receiving sets of concurrent measurements from the motion sensors and from the magnetometer, at S1210.

The method 1200 further includes determining parameters for calculating a measured magnetic field based on measurements among the sets of concurrent measurements received from the magnetometer, the determining being performed using a current roll, pitch and relative yaw obtained from measurements among the set of concurrent measurements received from the motion sensors, at least some of the parameters being determined analytically, at S1220. This operation may be performed using any of the methods for determining (calibrating) attitude-independent parameters and methods for determining (calibrating) attitude-dependent parameters (i.e., for aligning the magnetometer) according to the exemplary embodiments described above.

The disclosed exemplary embodiments provide methods that may be part of a toolkit useable when a magnetometer is used in combination with other sensors to determine orientation of a device, and systems capable to use the toolkit. The methods may be embodied in a computer program product. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. A method for estimating a yaw angle of a body reference system of a device relative to a gravitational reference system, using motion sensors and a magnetometer attached to the device, the method comprising:
receiving measurements from the motion sensors and from the magnetometer;
determining a measured 3-D magnetic field, a roll angle, a pitch angle and a raw estimate of yaw angle of the device in the body reference system based on the received measurements;
extracting a local 3-D magnetic field from the measured 3-D magnetic field; and
calculating a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect the error of the tilt-compensated yaw angle differently for the at least two different methods.

2. The method of claim 1, wherein the local 3-D magnetic field is corrected for one or more of soft-iron effect, hard-iron effect and relative alignment of the magnetometer relative to the body reference system.

3. The method of claim 1, wherein the local 3-D magnetic field is compensated for dynamic near fields.

4. The method of claim 1, wherein the gravitational reference system is an Earth-fixed orthogonal reference system defined relative to gravity and an Earth's magnetic field direction.

5. The method of claim 1, wherein the received measurements are concurrent measurements.

6. The method of claim 3, wherein the local 3-D magnetic field is compensated for dynamic near fields based on tracking evolution of the measured 3-D magnetic field.

7. The method of claim 1, wherein the measured 3-D magnetic field is calculated using parameters related to sensor's intrinsic characteristics.

8. The method of claim 7, wherein the parameters related to sensor's intrinsic characteristics include one or more of an offset, a scale and a skew/cross-coupling matrix.

9. The method of claim 1, wherein:
the motion sensors include an accelerometer whose measurements are used to determine a tilt of the body reference system of the device relative to gravity.

10. The method of claim 1, wherein the calculating includes estimating an error of the tilt compensated yaw angle.

11. The method of claim 1, wherein the calculating includes:
obtaining roll and pitch in another reference system related to the device and having a z-axis along gravity, and
estimating a static magnetic field in the gravitational reference system.

12. The method of claim 11, wherein the obtaining includes estimating an angle between the static local magnetic field and a direction opposite to gravity.

13. The method of claim 1, wherein errors of the tilt compensated yaw angle calculated using each of the at least two different methods are estimated, and a value of the tilt compensated yaw angle corresponding to a smallest of the estimated errors is output.

14. The method of claim 1, wherein one of the at least two methods calculates the yaw angle to as
$${{ϕ}^{⋒}}_{n} = {tan}^{- 1} ( \frac{sin {\hat{θ}}_{n} \cdot ( sin {\hat{φ}}_{n} \cdot {\hat{E}}_{⊥ A {g}_{n}} ( Z ) - cos {\hat{φ}}_{n} \cdot {\hat{E}}_{⊥ {Ag}_{n}} ( Y ) )}{sin {\hat{φ}}_{n} \cdot {\hat{E}}_{⊥ A {g}_{n}} ( Y ) + cos {\hat{φ}}_{n} \cdot {\hat{E}}_{⊥ {Ag}_{n}} ( Z )} )$$
where \hat{θ}ₙ and \hat{φ}ₙ are tilt corrected roll and pitch,
Ê_{⊥Ag}_{ₙ}□ sin \hat{α}ₙ·^{D}{tilde over (\hat{B}_{⊥Ag}_{ₙ}, where Ê_{⊥Ag}_{ₙ}(Y) and Ê_{⊥Ag}_{ₙ}(Z) are components of Ê_{⊥Ag}_{ₙ} in the gravitational reference system calculated using the raw estimate of the yaw,
$${\hat{α}}_{n} = {cos}^{- 1} ( \frac{{}_{}^{D}{\hat{\tilde{B}}}{}_{• {Ag}_{n}}^{} \cdot {}_{}^{D}{\hat{B}}{}_{n}^{}}{\vert {}_{}^{D}{\hat{B}}{}_{n}^{} \vert} )$$
is an angle between the extracted local 3-D magnetic field and a direction opposite to gravity,
^{D}\hat{B}ₙ is an estimate of the local 3-D magnetic field in the body reference system
^{D}{tilde over (\hat{B}_{□Ag}_{ₙ} is an estimate of a component parallel to gravity of the local 3-D magnetic field in the body reference system, and
^{D}{tilde over (\hat{B}_{⊥Ag}_{ₙ} is an estimate of a component perpendicular to gravity of the local 3-D magnetic field in the body reference system.

15. The method of claim 1, wherein one of the at least two methods calculates the yaw angle to as
$${{ϕ}^{⋒}}_{n} = {tan}^{- 1} ( \frac{sin {\hat{θ}}_{n} \cdot ( sin {\hat{φ}}_{n} \cdot {\hat{E}}_{⊥ A {g}_{n}} ( Z ) - cos {\hat{φ}}_{n} \cdot {\hat{E}}_{⊥ {Ag}_{n}} ( Y ) )}{sin {\hat{φ}}_{n} \cdot {\hat{E}}_{⊥ A {g}_{n}} ( Y ) + cos {\hat{φ}}_{n} \cdot {\hat{E}}_{⊥ {Ag}_{n}} ( Z )} )$$
where \hat{θ}ₙ and \hat{φ}ₙ are tilt corrected roll and pitch,
Ê_{⊥Ag}_{ₙ}□ sin \hat{α}ₙ·^{D}{tilde over (\hat{B}_{⊥Ag}_{ₙ}, where Ê_{⊥Ag}_{ₙ}(X), Ê_{⊥Ag}_{ₙ}(Y) and Ê_{⊥Ag}_{ₙ}(Z) are components of Ê_{⊥Ag}_{ₙ} in the gravitational reference system calculated using the raw estimate of the yaw,
$${\hat{α}}_{n} = {cos}^{- 1} ( \frac{{}_{}^{D}{\hat{\tilde{B}}}{}_{• {Ag}_{n}}^{} \cdot {}_{}^{D}{\hat{B}}{}_{n}^{}}{\vert {}_{}^{D}{\hat{B}}{}_{n}^{} \vert} )$$
is an angle between the extracted local 3-D magnetic field and a direction opposite to gravity,
^{D}\hat{B}ₙ is an estimate of the local 3-D magnetic field in the body reference system
^{D}{tilde over (\hat{B}_{□Ag}_{ₙ} is an estimate of a component parallel to gravity of the local 3-D magnetic field in the body reference system, and
^{D}{tilde over (\hat{B}_{⊥Ag}_{ₙ} is an estimate of a component perpendicular to gravity of the local 3-D magnetic field in the body reference system.

16. The method of claim 1, wherein one of the at least two methods calculates the yaw angle to as
$${{ϕ}^{⋒}}_{n} = {tan}^{- 1} ( \frac{cos {\hat{θ}}_{n} \cdot ( sin {\hat{φ}}_{n} \cdot {\hat{E}}_{⊥ A {g}_{n}} ( Z ) - cos {\hat{φ}}_{n} \cdot {\hat{E}}_{⊥ {Ag}_{n}} ( Y ) )}{{\hat{E}}_{⊥ A {g}_{n}} ( X )} )$$
where \hat{θ}ₙ and \hat{φ}ₙ are tilt corrected roll and pitch,
Ê_{⊥Ag}_{ₙ}□ sin \hat{α}ₙ·^{D}{tilde over (\hat{B}_{⊥Ag}_{ₙ}, where Ê_{⊥Ag}_{ₙ}(X), Ê_{⊥Ag}_{ₙ}(Y) and Ê_{⊥Ag}_{ₙ}(Z) are components of Ê_{⊥Ag}_{ₙ} in the gravitational reference system calculated using the raw estimate of the yaw,
$${\hat{α}}_{n} = {cos}^{- 1} ( \frac{{}_{}^{D}{\hat{\tilde{B}}}{}_{• {Ag}_{n}}^{} \cdot {}_{}^{D}{\hat{B}}{}_{n}^{}}{\vert {}_{}^{D}{\hat{B}}{}_{n}^{} \vert} )$$
is an angle between the extracted local 3-D magnetic field and a direction opposite to gravity,
^{D}\hat{B}ₙ is an estimate of the local 3-D magnetic field in the body reference system
^{D}{tilde over (\hat{B}_{□Ag}_{ₙ} is an estimate of a component parallel to gravity of the local 3-D magnetic field in the body reference system, and
^{D}{tilde over (\hat{B}_{⊥Ag}_{ₙ} is an estimate of a component perpendicular to gravity of the local 3-D magnetic field in the body reference system.

17. The method of claim 6, wherein dynamic near fields are tracked using first values of the measured 3-D magnetic field corresponding to different time steps and second values of the magnetic field that are predicted using a magnetic field model, wherein the first values and the second values are compared to determine whether the measured 3-D magnetic field is different from what the magnetic field model predicts.

18. The method of claim 17, wherein if a result of comparing is that the measured 3-D magnetic field is not different from what the magnetic field model predicts, an error of yaw angle is estimated.

19. The method of claim 17, wherein if a result of comparing is that the measured 3-D magnetic field is not different from what the magnetic field model predicts, an error of roll angle is estimated.

20. The method of claim 17, wherein if a result of comparing is that the measured 3-D magnetic field is not different from what the magnetic field model predicts, an error of pitch angle is estimated.

21. The method of claim 17, wherein if a result of comparing is that the measured 3-D magnetic field is different from what the magnetic field model predicts, the magnetic field model is updated.

22. The method of claim 1, wherein:
the motion sensors includes inertial sensors whose measurements yield an inertial sensor yaw angle, and
the calculating includes determining a best yaw angle estimate based on the tilt compensated yaw angle and the inertial sensor yaw angle,
wherein the determining of the best yaw estimate includes computing errors associated with the tilt compensated yaw angle and the inertial sensor yaw angle.

23. The method of claim 22, wherein the determining includes using an adaptive filter to combine the tilt compensated yaw angle and the inertial sensor yaw angle.

24. The method of claim 23, wherein the determining includes calculating an adaptive filter's gain coefficient using a computed total estimate error based on one or more of calibration accuracy, a yaw angle computation error resulting from sensor noise, roll and pitch estimate error, and a near field compensation error.

25. The method of claim 24, wherein the adaptive filter's coefficient is a ratio of an absolute value of an innovation variable divided by the total estimate error, the innovation variable being a difference between a current yaw angle inferred from magnetometer measurements and a predicted best estimate of yaw angle from a previous output of the adaptive filter.

26. The method of claim 24, wherein the adaptive filter's coefficient is a ratio of a first square of a predicted yaw error when using the inertial sensors and a second square of the total estimate error.

27. The method of claim 24, wherein the adaptive filter's coefficient is 1 if the total estimate error is smaller than a predetermined threshold value, and, otherwise is a function of a ratio of an absolute value of an innovation variable divided by a predicted yaw angle error when using the inertial sensors, the innovation variable being a difference between a current yaw angle inferred from magnetometer measurements and a predicted best estimate of yaw angle from a previous output of the adaptive filter.

28. The method of claim 24, wherein the adaptive filter's coefficient is 1 if an innovation variable is smaller than a predetermined threshold value, and, otherwise is a predetermined small value.

29. The method of claim 24, wherein the adaptive filter's coefficient is a product of two or more of:
(1) a ratio of an absolute value of an innovation variable divided by the total estimate error,
(2) a ratio of a first square of a predicted yaw error when using the inertial sensors and a second square of the total estimate error,
(3) 1 if the total estimate error is smaller than a first predetermined threshold value, and, otherwise, a function of a ratio of an absolute value of the innovation variable divided by the predicted yaw angle error when using the inertial sensors,
(4) 1 if the innovation variable is smaller than a second predetermined threshold value, and, otherwise, a predetermined small value, and
the innovation variable being a difference between a current yaw angle inferred from magnetometer measurements and a predicted best estimate of yaw angle from a previous output of the adaptive filter.

30. The method of claim 24, wherein the best yaw angle estimate is a sum of a predicted yaw angle from the inertial sensors based on a best yaw estimate from a previous step and a product of an innovation variable and a function of the adaptive filter's coefficient, the innovation variable being a difference between a current yaw angle inferred from magnetometer measurements and a predicted best estimate of yaw angle from a previous output of the adaptive filter.

31. An apparatus, comprising:
a device having a rigid body;
a 3-D magnetometer mounted on the device and configured to generate measurements corresponding to a local magnetic field;
motion sensors mounted on the device and configured to generate measurements corresponding to orientation of the rigid body; and
at least one processing unit configured
(1) to receive measurements from the motion sensors and from the magnetometer;
(2) to determine a measured 3-D magnetic field, a roll angle, a pitch angle and a raw estimate of yaw angle of the device in the body reference system based on the received measurements;
(3) to extract a local 3-D magnetic field from the measured 3-D magnetic field; and
(4) to calculate a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect the error of the tilt-compensated yaw angle differently for the at least two different methods.

32. The apparatus of claim 31, wherein the at least one processing unit includes a processing unit disposed within the device which is configured to executed at least one of (1)-(4).

33. The apparatus of claim 31, wherein the at least one processing unit includes a processing unit located remotely and configured to execute at least one of (1)-(4), and the apparatus further comprises a transmitter mounted on the device and configured to transmit data to the processing unit located remotely.

34. A computer readable storage medium configured to store executable codes which when executed on a computer make the computer to perform a method for estimating a yaw angle of a body reference system of a device relative to a gravitational reference system, using motion sensors and a magnetometer attached to the device, the method comprising:
receiving measurements from the motion sensors and from the magnetometer;
determining a measured 3-D magnetic field, a roll angle, a pitch angle and a raw estimate of yaw angle of the device in the body reference system based on the received measurements;
extracting a local 3-D magnetic field from the measured 3-D magnetic field; and
calculating a tilt-compensated yaw angle of the body reference system of the device in the gravitational reference system based on the extracted local 3-D magnetic, the roll angle, the pitch angle and the raw estimate of yaw angle using at least two different methods, wherein an error of the roll angle estimate, an error of the pitch angle estimate, and an error of the extracted local 3-D magnetic field affect the error of the tilt-compensated yaw angle differently for the at least two different methods.
